(19) United States
(12) Patent Application Publication
(10) Pub. No.: US 2016/0351018 A1
(43) Pub. Date: Dec. 1, 2016

(54) AUTOMATED COMMUNAL PLAY OF BLACKJACK

(71) Applicant: Gamesys Ltd., London (GB)

(72) Inventors: Robeson Mandela Reeves, London (GB); Hans Elias, St. Albans (GB)

(21) Appl. No.: 15/170,552

(22) Filed: Jun. 1, 2016

Related U.S. Application Data
(60) Provisional application No. 62/169,074, filed on Jun. 1, 2015.

(51) Int. Cl. G07F 17/32

(52) U.S. Cl. CPC G07F 17/3293; G07F 17/3276

(57) ABSTRACT

Systems, methods, and articles of manufacture provide for online and/or electronic card games such as blackjack that are provided in an automated communal fashion to provide for a wider and more diverse audience of players.

### CROSS-REFERENCE TO RELATED APPLICATIONS

This application is a non-provisional of, and claims benefit and priority to, U.S. Provisional Patent Application No. 62/169,074 filed on Jun. 1, 2015 and titled “AUTOMATED COMMUNAL PLAY OF BLACKJACK”, the contents of which are hereby incorporated by reference herein.

### BACKGROUND

Card games, using either physical or virtual playing cards, remain a fundamental source of entertainment. Some card games are complex and accordingly tailored to more advanced or skilled players, while other card games are simpler and are accordingly more enjoyable or more easily played by new or novice players. Even more simplistic card games such as Blackjack, however, can include complexities and variations of game play that are disincentives for new or novice players. In practice, and because of even minor game play complexities, variations, or options, even simple card games are predominantly frequented by experienced players, with new or novice players being excluded, and revenues (from entertainment via social games and/or from wager revenues for gambling venues) are accordingly negatively impacted.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a block diagram of a system according to some embodiments;

FIG. 4 is a block diagram of a system according to some embodiments;

FIG. 5 is a block diagram of a system according to some embodiments;

FIG. 6 is a flow diagram of a method according to some embodiments;

FIG. 7A, FIG. 7B, and FIG. 7C are illustrations of an example game interface according to some embodiments;

FIG. 8 is a programmatic flowchart of a data processing method according to some embodiments;

FIG. 9 is a block diagram of an apparatus according to some embodiments; and

FIG. 10A, FIG. 10B, FIG. 10C, FIG. 10D, and FIG. 10E are perspective diagrams of exemplary data storage devices according to some embodiments.

### DETAILED DESCRIPTION

### I. Introduction

Embodiments described herein are generally descriptive of systems, methods, apparatus, and articles of manufacture for facilitating an electronic card game (such as blackjack) in which a player places a bet on a game event (e.g., a resolution of a plurality of hands of blackjack which are played contemporaneously), which game event is also available for betting on by other players (such that a plurality of players may place a bet on the resolution of the same set of blackjack hands). In accordance with some embodiments, the outcome of the game event (e.g., resolution of a plurality of hands of blackjack) is determined (e.g., computed) based on decisions for how to proceed during the game event (e.g., decisions concerning whether an additional card should be dealt to an initial hand or whether the initial hand should be kept as the final hand) which are made by a processor of a computing device, in accordance with a game program (e.g., in an “automated” fashion), rather than being based on decisions made by the individual players (e.g., “auto play” as opposed to user-driven or user-interactive game play).

### A. Typical Blackjack Game Play

In traditional blackjack, a player determines a wager for each individual hand and places the wager. The player is initially dealt two cards (the “initial hand” or “initial cards”) and must then make a decision regarding these initial cards (a game play decision, which may include options such as whether to ask for an additional card (“hit”), stay with just the two initial cards (“stand”), split the two cards into two separate hands (“split”), or double an initial wager (“double down”)). A final hand is then determined (which may comprise only the two initial cards dealt if the player elected to “stand” or may include at least one additional card dealt to the player if the player's game play decision was to request additional card(s) be dealt). At the same time, a dealer's initial hand and final hand (based on game play decisions of the dealer or automated game play decisions made by a processor on behalf of the dealer) is determined. The game event is then resolved by comparing the final hand of the player to the final hand of the dealer (unless the player “busts” by obtaining a final hand whose value is over twenty-one (21), in which case no comparison to the dealer's hand may be necessary). If the player's final hand is determined to be the winning hand over the dealer's final hand, an appropriate amount of winnings is provided to the player (e.g., an appropriate amount of credits is added to a credit balance of the player). This process is repeated for each final hand. A side effect of this process is that a player who may not know how to play (e.g., make good game play decisions as to whether to take an additional card, stand or split the initially cards dealt) or may not feel they know how to make the best decisions for particular initial cards dealt in a hand of blackjack in order to maximize their rate of return may be discouraged from playing blackjack. For example, a player may be a novice at playing blackjack, and may not know when to hit, double down or stay on a particular hand. A player who does not know how to play blackjack, for example, may be discouraged from continued or future play by losing multiple bets.

### B. “Automated” Communal Blackjack Game Play

Embodiments described herein provide for allowing a player to place a wager on one or more hands of blackjack and resolving the hand(s) without input and/or game play decisions from the player. Rather, the game play decisions are made on behalf of the player by a processor executing instructions of a game program (e.g., “automated” game pay logic), in accordance with, for example, optimal or “perfect” game play rules which are defined to maximize the rate of return for the player (e.g., are statistically derived to provide for the most probable outcomes based on initial cards or hands dealt). An example of optimal or “perfect” game play decisions for a game of blackjack is provided in Table 1 below.

TABLE 1
Example Optimal Game Play Decisions for Blackjack

| | Dealer's face-up card | | | | | | | | | |
|---|---|---|---|---|---|---|---|---|---|---|
| Player hand | 2 | 3 | 4 | 5 | 6 | 7 | 8 | 9 | 10 | A |

Hard totals (excluding pairs)

| | | | | | | | | | | |
|---|---|---|---|---|---|---|---|---|---|---|
| 17-20 | S | S | S | S | S | S | S | S | S | S |
| 16 | S | S | S | S | S | H | H | SU | SU | SU |
| 15 | S | S | S | S | S | H | H | H | SU | H |
| 13-14 | S | S | S | S | S | H | H | H | H | H |
| 12 | H | H | S | S | S | H | H | H | H | H |
| 11 | Dh | Dh | Dh | Dh | Dh | Dh | Dh | Dh | Dh | H |
| 10 | Dh | Dh | Dh | Dh | Dh | Dh | Dh | Dh | H | H |
| 9 | H | Dh | Dh | Dh | Dh | H | H | H | H | H |
| 5-8 | H | H | H | H | H | H | H | H | H | H |

Soft totals

| | | | | | | | | | | |
|---|---|---|---|---|---|---|---|---|---|---|
| A,8-A,9 | S | S | S | S | S | S | S | S | S | S |
| A,7 | S | Ds | Ds | Ds | Ds | S | S | H | H | H |
| A,6 | H | Dh | Dh | Dh | Dh | H | H | H | H | H |
| A,4-A,5 | H | H | Dh | Dh | Dh | H | H | H | H | H |
| A,2-A,3 | H | H | H | Dh | Dh | H | H | H | H | H |

Pairs

| | | | | | | | | | | |
|---|---|---|---|---|---|---|---|---|---|---|
| A,A | SP | SP | SP | SP | SP | SP | SP | SP | SP | SP |
| 10,10 | S | S | S | S | S | S | S | S | S | S |
| 9,9 | SP | SP | SP | SP | SP | S | SP | SP | S | S |
| 8,8 | SP | SP | SP | SP | SP | SP | SP | SP | SP | SP |
| 7,7 | SP | SP | SP | SP | SP | SP | H | H | H | H |
| 6,6 | SP | SP | SP | SP | SP | H | H | H | H | H |
| 5,5 | Dh | Dh | Dh | Dh | Dh | Dh | Dh | Dh | H | H |
| 4,4 | H | H | H | SP | SP | H | H | H | H | H |
| 2,2-3,3 | SP | SP | SP | SP | SP | SP | H | H | H | H |

Key:
S = Stand
H = Hit
Dh = Double (if not allowed, then hit)
Ds = Double (if not allowed, then stand)
SP = Split
SU = Surrender (if not allowed, then hit)

In accordance with some embodiments, the systems and methods described herein provide for a mechanism via which players may place a wager on a plurality of hands at the same time, such that the plurality of hands are resolved contemporaneously as part of a single game event. In accordance with some embodiments, the systems and methods described herein provide for allowing a plurality of players to bet on the same game event which includes the plurality of hands (e.g., participating in game play from individual player devices, which may be located in locations remote from one another and remote from the game server, such as from individual computers or mobile devices participating in an online blackjack game). For example, a game server may open betting for a plurality of hands that are to be resolved contemporaneously as part of the same game event, based on application of game decision rules (e.g., “automated play” logic) of a game program such that none of the players who elect to “join” the game event by placing a wager on the plurality of hands comprising the game event provide game play decisions before or during resolution of the hands (or in some embodiments, are specifically barred or prevented from providing game play instructions or input beyond the initial placement of the wager). Such game play events which resolve hands based on application of programmed automated game play rules rather than input of player decisions and which allow multiple players to join or bet on the same game event (and thus, e.g., be paid out based on the result of the game event which is resolved based on the programmed game play rules rather than player game play decisions) may be referred to herein as “automated communal play”, and a game system which operates in accordance with such embodiments may be referred to as operating in an “automated communal mode”.

One advantage of automated communal play is that it facilitates introduction of blackjack to novice players by minimizing the possibility of sub-optimal return to players through poor play since the game program resolves the hands according to established (e.g., pre-programmed) blackjack strategies which maximize the return to the players. In some embodiments, the game program may further simplify the game for players by not including certain more advanced options or choices from possible game decisions, which may require more experience and/or strategy to implement. For example, in some embodiments, doubling down may be removed from the list of play options, and/or splitting may be allowed, but, e.g., without increasing the cost of the wager. In other embodiments, automated communal play blackjack may provide no other option to players other than to place an initial wager. For example, automated communal play blackjack may not allow players to make any decisions at all after the players' initial decision to place a wager.

In some embodiments, a processor, for example, will automatically play player position hands in a blackjack game so that players do not have any decisions to make. For example, after players place their wagers, the game will play automatically until the hand is resolved and/or the game is over. The processor, in some embodiments, will interrogate a database storing blackjack instructions based on well-established strategies (e.g., instructions based on optimal game play decisions such as those illustrated in Table 1 above) that provide for the best returns to players. In one or more embodiments, the game play history may be stored and displayed in a manner similar to that used in a number display on a roulette game.

In some embodiments, automated communal play may encourage a community element with multiple players playing the same hands without having to deal with different player decisions on those hands. For example, a table with three (3) player positions (a “player position” or “position” being an area of a game interface in which hands for a particular hand are dealt, and which may be wagered on individually) may have three (3) hands played simultaneously, regardless of whether a wager has been placed on every station, and/or players may select stations to play. In some embodiments, all stations are dealt and handled according to the same rules, and regardless of whether players have placed wagers on those stations. In other embodiments, multiple players can each place wagers and wager on all three (3) player positions (or however many player positions comprise the table) simultaneously, or bet on the table rather than on individual player positions.

In some embodiments, automated communal mode may allow players to play the same hands and experience the same outcomes. In one or more embodiments, players of automated communal play in a game of blackjack may wager on the same hands and receive payouts based on the way the automated communal mode plays particular hands. For example, payouts after resolution of a hand of blackjack can be based on the total bet on the game (for example, with three (3) hands in play, each win returns based on one third (⅓) of the game wager). When splitting, for example, the win amount from the split hands may be divided based on the total hands in play (for example, with three (3) hands in play, each hand may return one third (⅓) of the game wager, so each win of a split hand would return one sixth (⅙) of the game wager). In other embodiments, only the best final hand (for example, the “best final hand” may be the final hand either reaching or, alternatively, coming closest to, a value of twenty-one (21)) may win, and the payout may be a multiple of the total wager per player. Alternatively, this best final hand may only apply to split hands (wherein only the final hand within the split hand reaching or coming closest to a value of twenty-one (21) may be considered against the dealer's final hand, and the other final hand of the split hand is not considered).

One or more embodiments herein may allow for enhanced payout opportunities based on automated communal play. For example, payouts may include a bonus structure if all final hands beat the dealer's final hand. In some embodiments, bonus payouts may be progressive. For example, if all player positions of a blackjack game achieve blackjack (i.e., if final hands in each of the player positions have a value of twenty-one (21)) the bonus payouts may be increased in a manner commensurate with the number of stations in the blackjack game. In one or more embodiments, if a dealer hits blackjack (i.e., the dealer's final hand has a value of twenty-one (21)), the players will automatically retain half of their wagers. In some embodiments, an enhanced payout opportunity may be realized if, for example, the first six (6) cards dealt to player positions (in, for example, a blackjack game with three (3) player positions), and the first face up dealer card dealt to the dealer's station, represent a specific hand of poker (e.g., a full house, flush or straight) which qualifies for an enhanced payout or bonus (e.g., in the case that the defined poker hand matches a winning poke hand).

### C. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined generally throughout the present description.

A “game”, as the term is utilized herein (unless otherwise specified), may generally comprise any game (e.g., wagering or non-wagering, skill-based, chance-based, playable by hand (e.g., utilizing non-electric physical components, boards, and/or pieces), and/or electronically playable over a network) playable by one or more players in accordance with specified rules. An electronic game may be playable on a Personal Computer (PC), online in web browsers, on a game console, and/or on a mobile device such as a smart-phone or tablet computer. “Gaming” thus generally refers to play of a game (e.g., by one or more players).

A “casual game”, as the term is utilized herein (unless otherwise specified), may generally comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as utilized herein (unless otherwise specified), generally refers to a type of online game that is played through a social network, and in some embodiments may feature multiplayer and/or asynchronous game play mechanics. A “social network” may refer to an online service, online community, platform, and/or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a web browser and/or web-client game, a Flash®, or Java®-scripted game, and/or may be implemented on one or more mobile platforms such as on portable electronic devices.

A “wagering game”, as the term is utilized herein (unless otherwise specified), may generally comprise a game in which a player can risk a wager or other consideration, such as, but not limited to: slot-style games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” generally refers to play of a wagering game.

The term “game provider”, as utilized herein (unless otherwise specified), generally refers to an entity or system of components which provides games for play and facilitates play of such game by use of a network such as the Internet or a proprietary or closed network (e.g., an intranet or local or wide area network). For example, a game provider may operate a website which provides games in a digital format over the Internet. In some embodiments in which a game comprising a wagering game is provided, a game provider may operate a gambling website over which wagers are accepted and results (e.g., winnings) of wagering games are provided.

As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game.

Some embodiments described herein are associated with a “player device” or a “network device”. As utilized herein, a “player device” is a subset of a “network device”. The “network device”, for example, may generally refer to any device that can communicate via a network, while the “player device” may comprise a network device that is owned and/or operated by or otherwise associated with a player (e.g., a network device specifically configured to permit use thereof by the player, such as by receiving login credentials from the player). Examples of player and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components. In some embodiments, a player device may comprise an electronic device configured to initiate, conduct, facilitate, and/or otherwise permit player participation in an electronic game.

As utilized herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As utilized herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as utilized herein (unless otherwise specified), may generally refer to any indicia and/or other information indicative of or associated with a subject, item, entity, and/or other object and/or idea. As utilized herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

A “session”, as the term is utilized herein (unless otherwise specified), may generally comprise a period of time spanning a plurality of event instances (e.g., with respect to a communication and/or game session) or turns of a game, the session having a defined start and defined end. An event instance or turn is triggered upon an initiation of, or request for, at least one result of the game by a player, such as an actuation of a “start” or “spin” mechanism, which initiation causes an outcome to be determined or generated (e.g., an RNG is contacted or communicated with to identify, generate or determine a random number to be used to determine an outcome for the event instance).

As utilized herein, the terms “outcome” and “result” should be differentiated in the present description in that an “outcome” is generally a representation of a “result”, typically comprising one or more game elements or game symbols. For example, in a “fruit themed” slot-style game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three (3) spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass awards, prizes and payouts which are monetary, non-monetary, tangible or intangible.

As utilized herein, the term “virtual currency” may generally refer to an in-game currency that may be utilized as part of a game or one or more games provided by a game provider as (i) currency for making wagers, and/or (ii) to purchase or access various in-game items, features or powers (e.g., “freemium” upgrades and/or options).

A “credit balance”, as the term is utilized herein (unless otherwise specified), may generally refer to (i) a balance of currency, whether virtual currency and/or real currency, usable for making wagers and/or purchases in a game and/or (ii) another tracking mechanism for tracking a player's success or advancement in a game by deducting there from points or value for unsuccessful attempts at advancement and adding thereto points or value for successful attempts at advancement.

### II. Automated Communal Play Systems

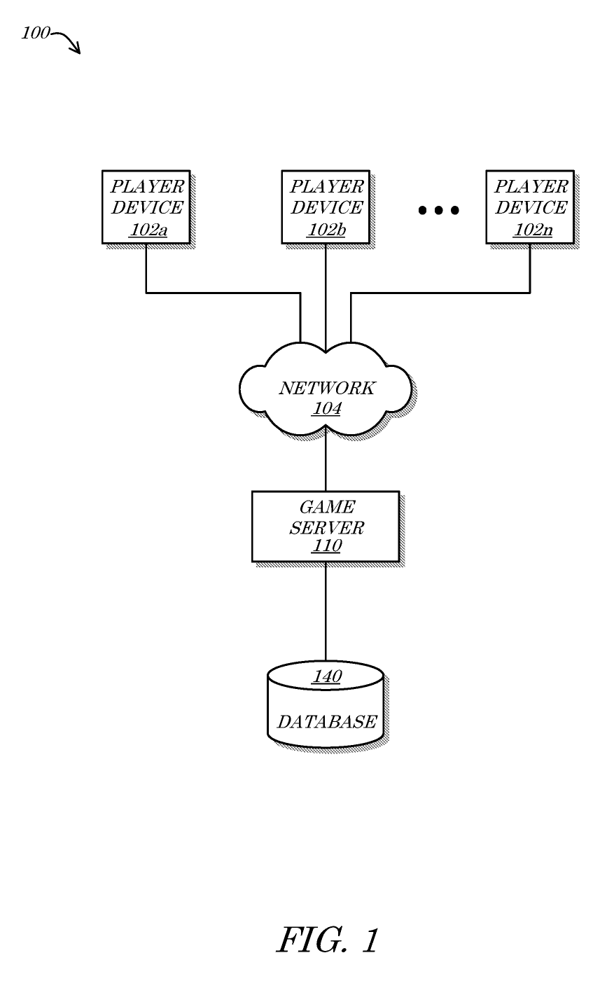

Referring now to FIG. 1, a block diagram of an example system 100 according to some embodiments is shown. The system 100 may comprise, for example, a plurality of player devices 102a-n in communication, e.g., via a network 104, with a game server 110. For simplicity of description only, any or all of the player devices 102a-n are referred to herein as a player device 102, even though the plurality of player devices 102a-n may include different quantities and/or types of player devices (as described below). The game server 110 may be operable to communicate with and/or access a database 140 (which may comprise one or more databases and/or tables and which may comprise a storage device distinct from (or be a component of) the game server 110). Database 140 may, for example, store rules enabling fully automated (e.g. “perfect”) blackjack strategy that may be employed by the game server such that a players' odds of winning are maximized. In some embodiments, database 140 may be stored on or by the game server 110 while in other embodiments database 140 may be stored on or by another computing device with which the game server 110 is operable to communicate in order to at least access the data in database 140 (e.g., another server device remote from game server 140, operable to determine outcomes for an event instance of a game; not shown). In some embodiments a processor (e.g., one or more microprocessors, one or more microcontrollers, one or more digital signal processors; not separately shown) of a player device 102 and/or game server 110 may receive instructions (e.g., from a memory or like device; e.g., the database 140), and execute those instructions, thereby performing one or more processes defined by those instructions. Instructions may be embodied in, e.g., one or more computer programs and/or one or more scripts or codes.

In some embodiments the game server 110 and/or one or more of the player devices 102a-n stores and/or has access to data useful for facilitating play of a game. In one or more embodiments, stored data and instructions may enable and/or cause automated communal play. For example, game server 110 and/or a player device 102 may store (i) one or more probability databases for determining one or more potential blackjack hand outcome(s) for a given event instance, or a specific hand during game play, (ii) a current state or status of a game or game session (e.g., a number of possibilities to play a given blackjack hand in order to, in some examples, maximize the probability for winning respective outcome(s), (iii) one or more user interfaces for use in a game, (iv) one or more game themes for a game and/or (v) profiles or other personal information associated with players of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

According to some embodiments, the game server 110 may comprise a computing device for facilitating play of a game (e.g., by receiving an input from a player, determining an outcome for a game, causing an outcome of a game to be displayed on a player device, determining a win result for a bet encompassing a plurality of hands or other game events, facilitating a wager and/or a provision of a payout for a game). For example, the game server 110 may comprise a server computer operated by a game provider or another entity (e.g., a social network website not primarily directed at providing games). In some embodiments, the game server may enable automated communal play that may determine how to play a given hand of blackjack to maximize payouts to players, and receive such an outcome from another remote server (not shown) operable to provide such outcomes. In some embodiments, the game server 110 may further be operable to facilitate an automated communal game program for automated communal play of a game. In accordance with some embodiments, in addition to administering or facilitating play of a game, the game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, the game server 110 may comprise two or more server computers operated by the same entity (e.g., one server being primarily for storing states of games in progress and another server being primarily for storing mechanisms for determining outcomes of games, such as a random number generator).

In accordance with some embodiments, the player device 102 may comprise a computing device that is operable to execute or facilitate the execution of a game program and used or useful by online players for accessing an online casino or other electronic (e.g., online) game provider or server. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ Playstation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). In some embodiments, the game server 110 may be in communication with a variety of different types of player devices 102a-n.

According to some embodiments, a player device 102 may be used to play a wagering or non-wagering game (e.g., a social or casual game) over a network and output information relating to the game to players participating in the game (e.g., outcomes for an event instance of the game, qualifying for a bonus round of the game, outcomes determined for a bet, a win result of a bet, credit balance of credits available for play of the game, etc.). Any and all information relevant to any of the aforementioned functions may be stored locally on one or more of the player devices 102 and/or may be accessed using one or more of the player devices 102 (in some embodiments such information being stored on, or provided via, the game server 110). In some embodiments, a player device 102 may store some or all of the program instructions for determining, for example, (i) that an event instance or game instance (e.g., a specific blackjack hand) has been triggered or initiated (and, in some embodiments, communicating such a trigger or initiation to game server 110), (ii) a win result for a bet (e.g., which may be dependent on a plurality of outcomes), and/or (iv) modifying a game interface to reflect events within the game. In some embodiments, the game server 110 may be operable to authorize the one or more player devices 102a-n to access such information and/or program instructions remotely via the network 104 and/or download from the game server 110 (e.g., directly or via an intermediary server such as a web server) some or all of the program code for executing one or more of the various functions described herein. In some embodiments, outcome and/or result determinations may be carried out by the game server 110 (or another server with which the game server 110 communicates) and the player devices 102 may be terminals for displaying to an associated player such outcomes and results and other graphics and data related to a game.

In some embodiments, the one or more player devices 102a-n may each be located at the same location as at least one other player device 102 (e.g., such as in a casino or internet café) or remote from all other player devices 102. Similarly, any given player device may be located at the same location as the game server 110 or may be remote from the game server 110. In some embodiments, while the game server 110 may be useful or used by any of the player devices 102 to perform certain functions described herein, the game server 110 need not control any of the player devices 102. For example, in some embodiments the game server 110 may comprise a server hosting a website of an online casino accessed by one or more of the player devices 102.

In some embodiments, a game server 110 may not be necessary or desirable. For example, some embodiments described herein may be practiced on one or more player devices 102a-n without a central authority. In such embodiments, any functions described herein as performed by the game server 110 and/or data described as stored on the game server 110 may instead be performed by or stored on one or more player devices 102a-n. Additional manners of distributing information and program instructions among one or more player devices 102a-n, the game server 110 and/or other network devices may be utilized in some embodiments.

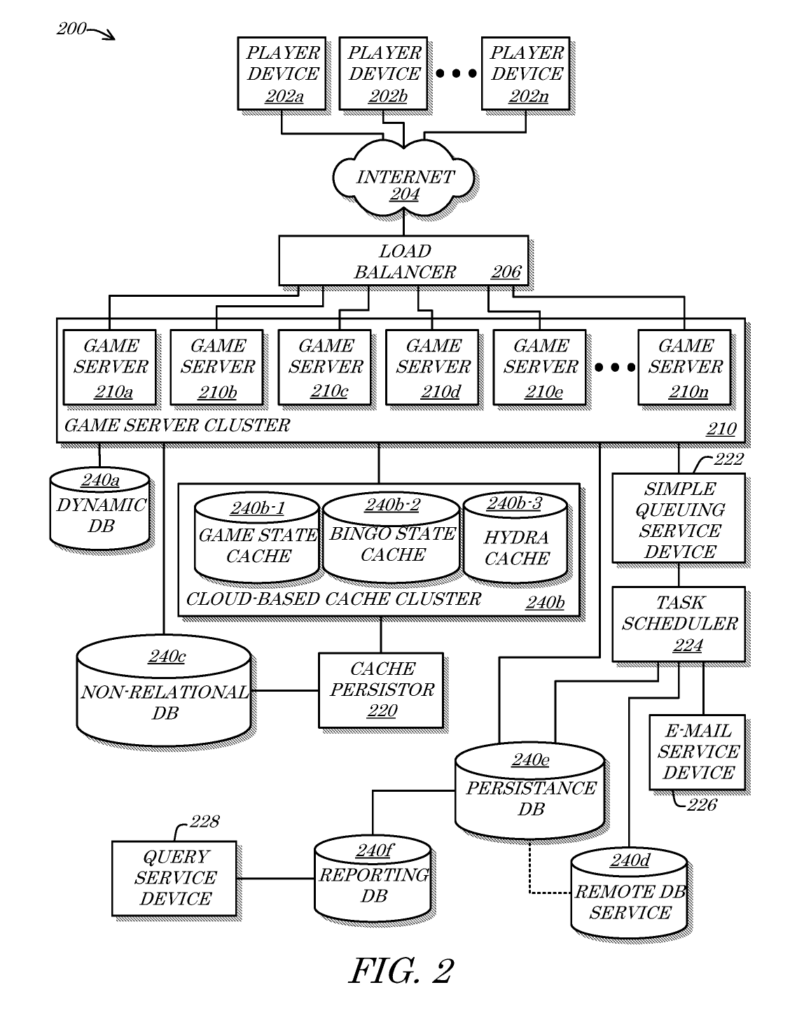

Turning to FIG. 2, a block diagram of a system 200 according to some embodiments is shown. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player devices 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online blackjack (e.g., automated communal blackjack as described herein), bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online automated communal blackjack game (or tournament), a second game server 210c may host a second particular instance of an online roulette game (or tournament), a third game server 210c may facilitate an online poker tournament, and/or a fourth game server 210d may provide an online slots game.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)). Such a broadcaster device may, for example, broadcast and/or output (or cause the output of; e.g., by transmitting command signals to a display device) any or all of wager options, wager time window data (e.g., opening and/or closing timing information for placing a wager in an automated play blackjack game), initial hand outcomes for a blackjack game, automated game play decisions, moves, and/or choices, final hand outcomes, and/or game results.

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., blackjack) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, blackjack state (e.g., auto-play blackjack game-specific state) data may be stored in the blackjack state cache 240b-2, and/or other game and/or player information (e.g., auto-play logic, progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game, secondary or bonus game, and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve information concerning a specific blackjack hand, and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

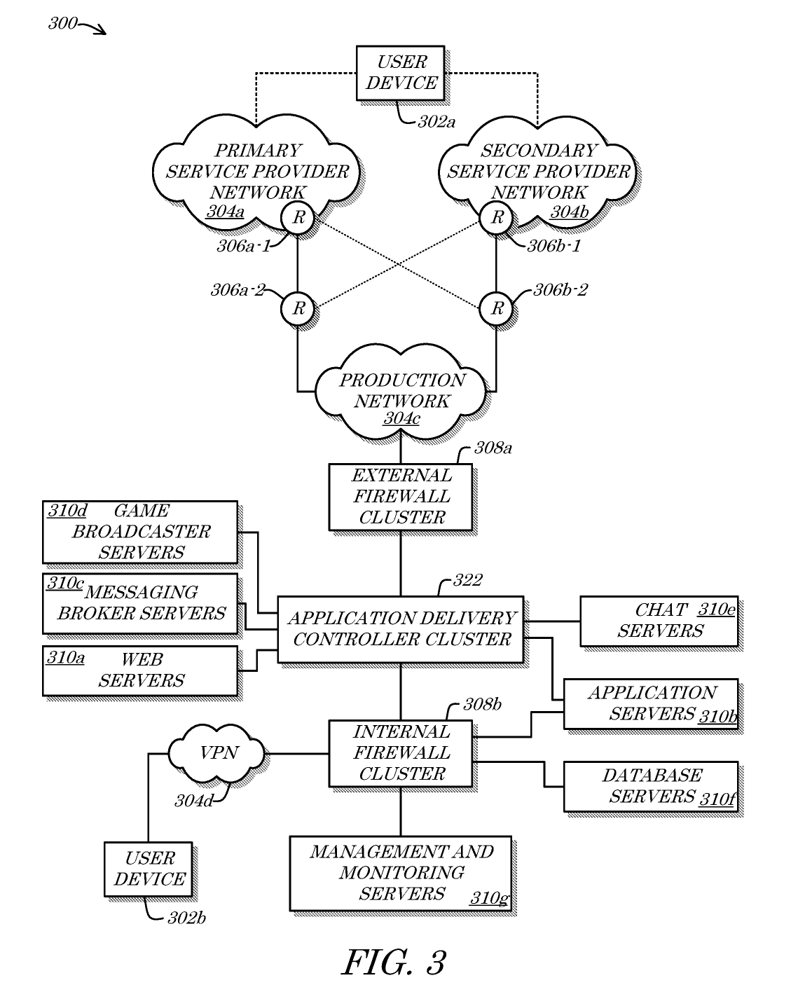

Turning now to FIG. 3, a block diagram of a system 300 according to some embodiments is shown. In some embodiments, the system 300 may comprise and/or define a “front-end” architecture of a gaming platform such as a platform via which social, multiplayer, and/or online games may be played (e.g., one or more automated communal blackjack games as described herein). In some embodiments, the system 300 may comprise a plurality of user devices 302a-b, a plurality of networks 304a-b (e.g., a primary service provider network 304a, a secondary service provider network 304b, a production network 304c, and/or a VPN 304d), a plurality of routers 306a-b, a plurality of firewall devices 308a-b, a plurality of game servers 310a-g (e.g., web servers 310a, application servers 310b, messaging broker servers 310c, game broadcaster servers 310d, chat servers 310e, database servers 310f, and/or management and monitoring servers 310g), and/or an application delivery controller cluster 322.

According to some embodiments, any or all of the components 302a-b, 304a-b, 306a-b, 308a-b, 310a-g, 322 of the system 300 may be similar in configuration and/or functionality to any similarly named and/or numbered components described herein. Fewer or more components 302a-b, 304a-b, 306a-b, 308a-b, 310a-g, 322 (and/or portions thereof) and/or various configurations of the components 302a-b, 304a-b, 306a-b, 308a-b, 310a-g, 322 may be included in the system 300 without deviating from the scope of embodiments described herein. While multiple instances of some components 302a-b, 304a-b, 306a-b, 308a-b, 310a-g are depicted and while single instances of other components 322 are depicted, for example, any component 302a-b, 304a-b, 306a-b, 308a-b, 310a-g, 322 depicted in the system 300 may comprise a single device, a combination of devices and/or components 302a-b, 304a-b, 306a-b, 308a-b, 310a-g, 322, and/or a plurality of devices, as is or becomes desirable and/or practicable. Similarly, in some embodiments, one or more of the various components 302a-b, 304a-b, 306a-b, 308a-b, 310a-g, 322 may not be needed and/or desired in the system 300.

In some embodiments, a first user device 302a may comprise an electronic device owned and/or operated by a player of an online game (not explicitly shown) and/or by an entity that otherwise accesses online game content and/or services externally (e.g., requiring external login and/or access credentials and/or procedures). The first user device 302a may, for example, be or comprise a smart phone, smart watch, tablet or personal computer capable of accessing a network. The first user device 302a may, for example, be utilized to access content provided by and/or via the application delivery controller cluster 322. In some embodiments, the first user device 302a may interface with and/or connect to the production network 304c via the primary service provider network 304a and/or the secondary service provider network 304b. The primary service provider network 304a and the secondary service provider network 304b may, for example, load balance and/or provide redundant coverage for outage recovery by utilization of a first primary service provider network router 306a-1, a second primary service provider network router 306a-2, a first secondary service provider network router 306b-1, and/or a second secondary service provider network router 306b-2.

According to some embodiments, the application delivery controller cluster 322 may be insulated and/or protected from the production network 304c by an external firewall cluster 308a. The first user device 302a may, for example, be required to provide credentials to and/or otherwise access the application delivery controller cluster 322 via the external firewall cluster 308a.

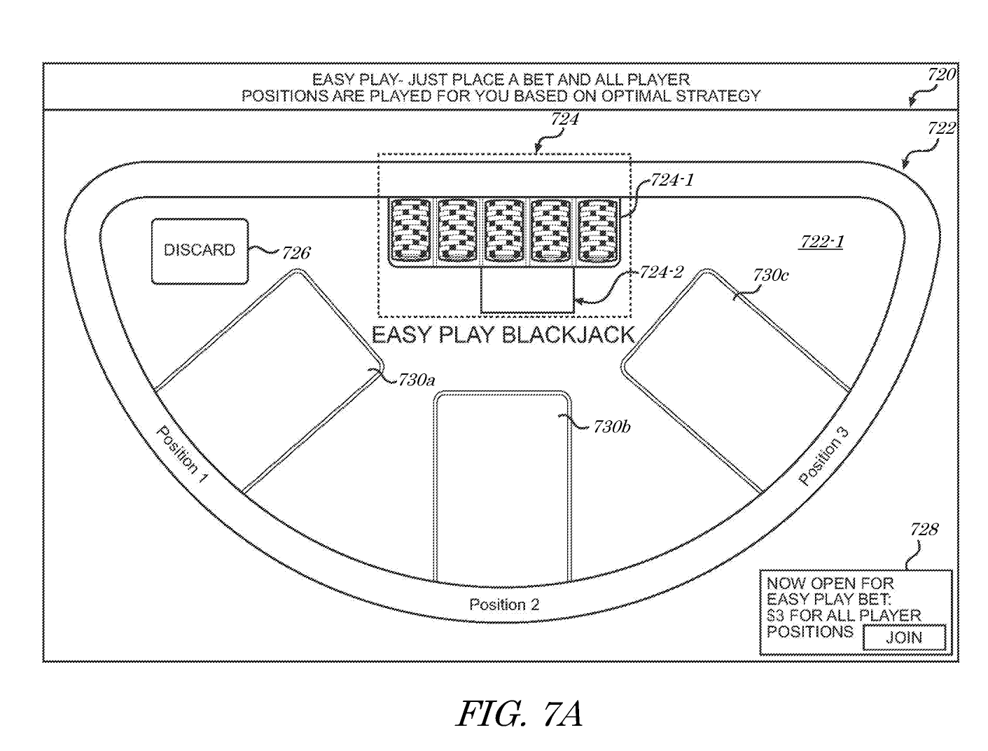

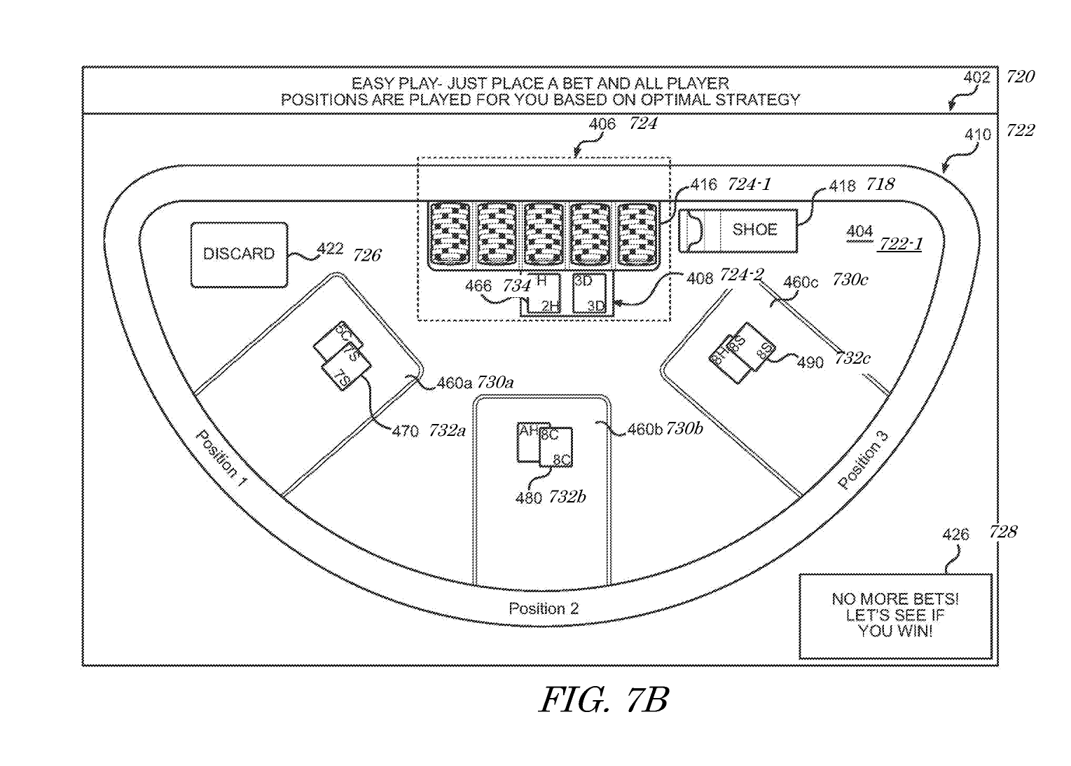

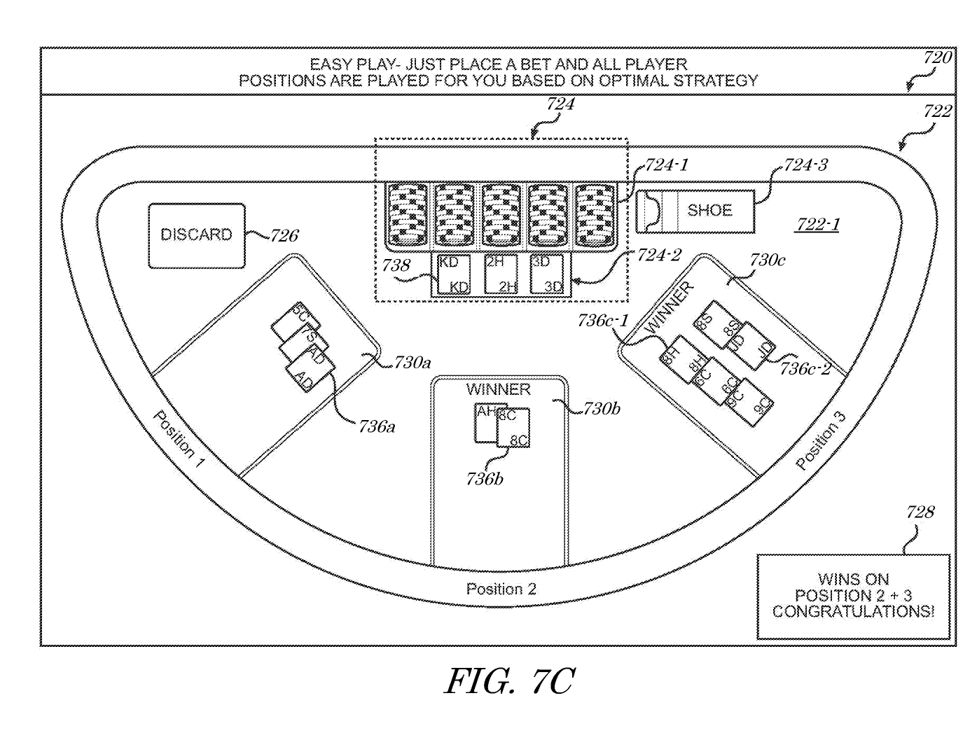

In some embodiments, the application delivery controller cluster 322 may receive via and/or from the external firewall cluster 308a and/or the production network 304c, one or more requests, calls, transmissions, and/or commands from the first user device 302a. The first user device 302a may, for example, submit a call for an online gaming interface (e.g., the interface 720 of FIG. 7A, FIG. 7B, and/or FIG. 7C herein) to the application delivery controller cluster 322. In some embodiments, the application delivery controller cluster 322 may comprise one or more hardware, software, and/or firmware devices and/or modules configured (e.g., specially-programmed) to route events and/or responses between the first user device 302a and one or more of the servers 310a-g. In the case that the first user device 302a is utilized to access an online gaming interface (not explicitly shown; e.g., the interface 720 of FIG. 7A, FIG. 7B, and/or FIG. 7C herein) for example, one or more of the web servers 310a (e.g., that may provide graphical and/or rendering elements for an interface and/or other web services) and/or the application servers 310b (e.g., that may provide rule and/or logic-based programming routines, elements, and/or functions—e.g., game play engines and/or automatic game play engines or logic modules) may be called and/or managed by the application delivery controller cluster 322.

In some embodiments, the messaging broker servers 310c may receive and/or retrieve messages from the first user device 302a (and/or from one or more of the other servers 310a-b, 310d-g) and perform one or more inter-application processes in relation thereto. The messaging broker servers 310c may, for example, route, transform, consolidate, aggregate, store, augment, and/or otherwise process one or more requests in connection with provision of online gaming services to the first user device 302a (e.g., facilitating a decoupling of services provided by various applications on and/or from the various servers 310a-b, 310d-g). According to some embodiments, the game broadcaster servers 310d may provide scheduled releases of information descriptive of an online game. The game broadcaster servers 310d may, for example, provide a broadcast feed of bingo numbers, slot and/or other random (and/or pseudo-random) number results, and/or automated game play decision information, that may be accessed by (and/or transmitted to) the first user device 302a (e.g., in connection with the play of an online automated communal blackjack, bingo, slots, and/or other game for which broadcast information may be utilized). In some embodiments, the chat servers 310e may provide, manage, and/or facilitate communications between the first user device 302a (and/or first user thereof) and one or more other player/user devices (such as a second user device 302b and/or other player/user devices not shown in FIG. 3).

According to some embodiments, the second user device 302b may generally comprise an electronic device owned and/or operated by a user (not shown) closely affiliated with an entity that operates the system 300 (such entity also not shown). An employee (e.g., programmer and/or Customer Service Representative (CSR)), contractor, and/or other agent of an online game provider may, for example, utilize the second user device 302b to interface with the privately-accessible VPN 304d. The VPN 304d may, for example, provide direct access to the application servers 310b, the database servers 310f, the management and monitoring servers 310g, and/or the application delivery controller cluster 322. In some embodiments (as depicted in FIG. 3), such access may be gated through and/or insulated or protected by an internal firewall cluster 308b. The second user device 302b may, for example, be required to provide credentials to and/or otherwise access the application delivery controller cluster 322 and/or servers 310a-g via the internal firewall cluster 308b.

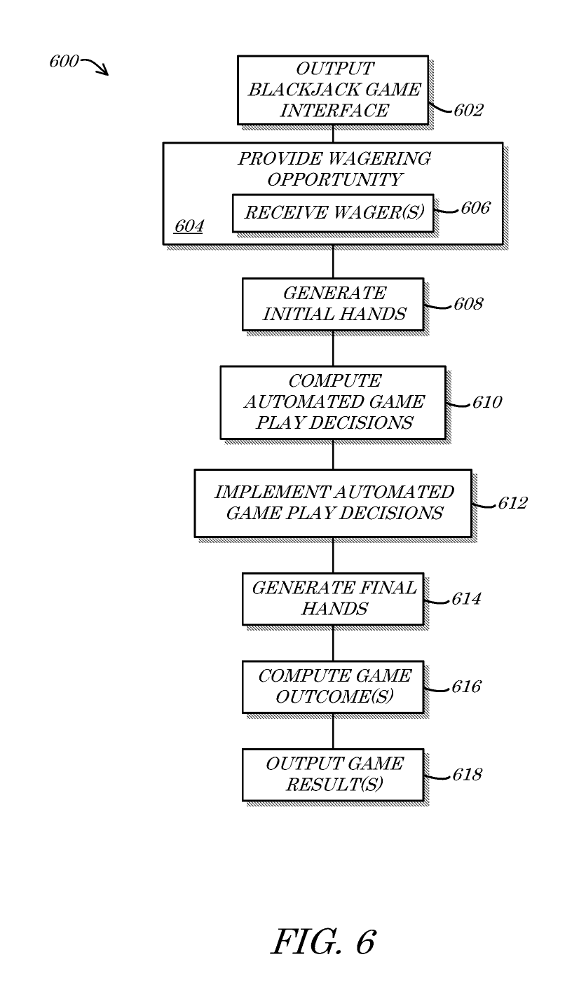

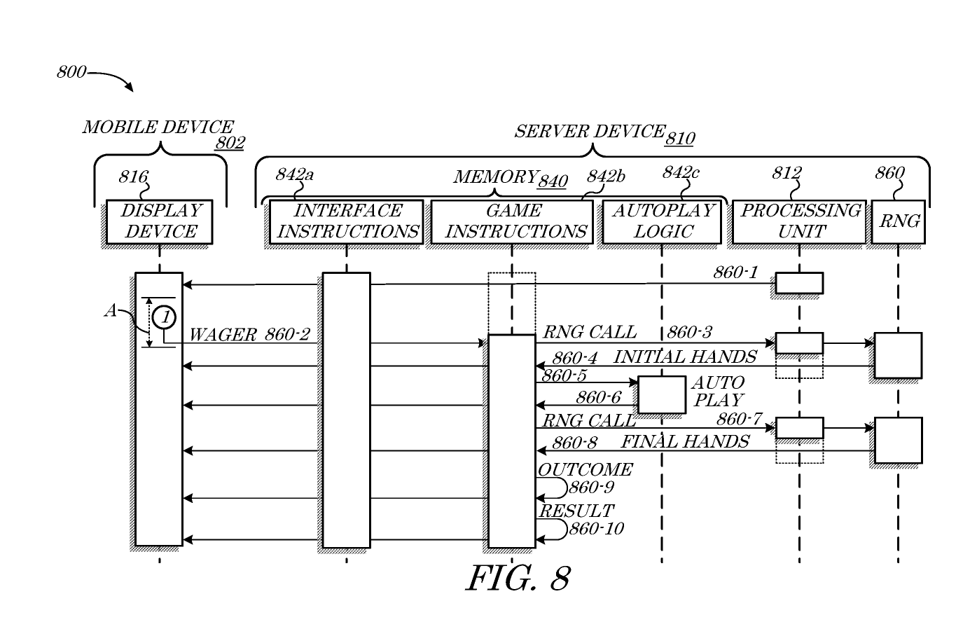

In some embodiments, the database servers 310f may provide access to one or more databases and/or data stores (e.g., not shown in FIG. 3; for data storage and/or retrieval). In some embodiments, the management and monitoring servers 310g may provide services such as monitoring, reporting, troubleshooting, analysis, configuring, etc. to the second user device 302b. The second user device 302b may, for example, access the management and monitoring servers 310g and/or the database servers 310f to run reports descriptive of online gaming operations, game play, and/or game referral setup, management, and/or analysis. According to some embodiments, either or both of the user devices 302a-b in conjunction with one or more of the servers 310a-g and/or the application delivery controller cluster 322 may conduct (in whole or in part), facilitate, and/or otherwise be associated with execution of one or more stored procedures, applications, processes, and/or methods (e.g., the methods 600, 800 of FIG. 6 and/or FIG. 8 herein, and/or one or more portions and/or combinations thereof) as described herein. In some embodiments, the user devices 302a-b in conjunction with one or more of the servers 310a-g and/or the application delivery controller cluster 322 may facilitate the execution of procedures, applications and processes that differ between the first user device 302a and the second user device 302b, creating different gaming experiences for the two users of these respective devices, even if playing the same game, in the same game session, etc.

Utilization of the term “server” with respect to the servers 310a-g of the system 300 of FIG. 3 is meant solely to ease description of the configuration and/or functionality of the servers 310a-g. The term “server” is not intended to be limiting with respect to any particular hardware, software, firmware, and/or quantities thereof utilized to implement any or all of the servers 310a-g of the system 300. Similarly, while multiple types and/or instances of the severs 310a-g are depicted in FIG. 3, any or all of the servers 310a-g may be implemented in, on, and/or by one or multiple computer server and/or other electronic devices.

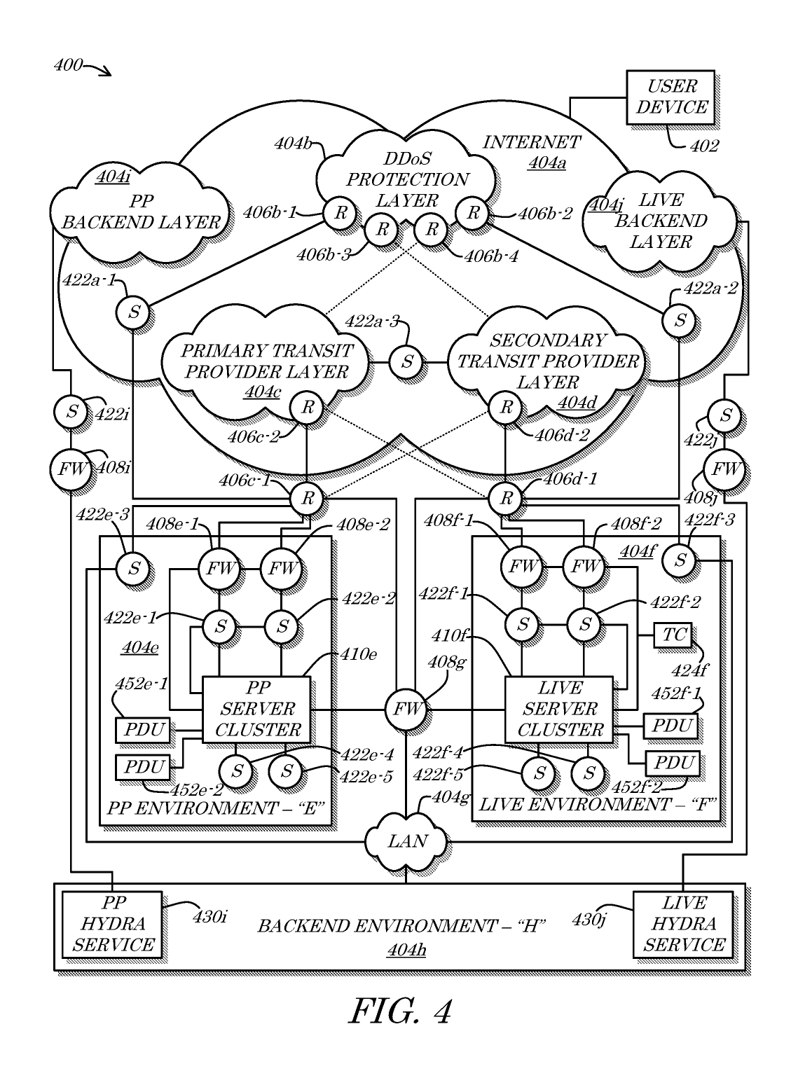

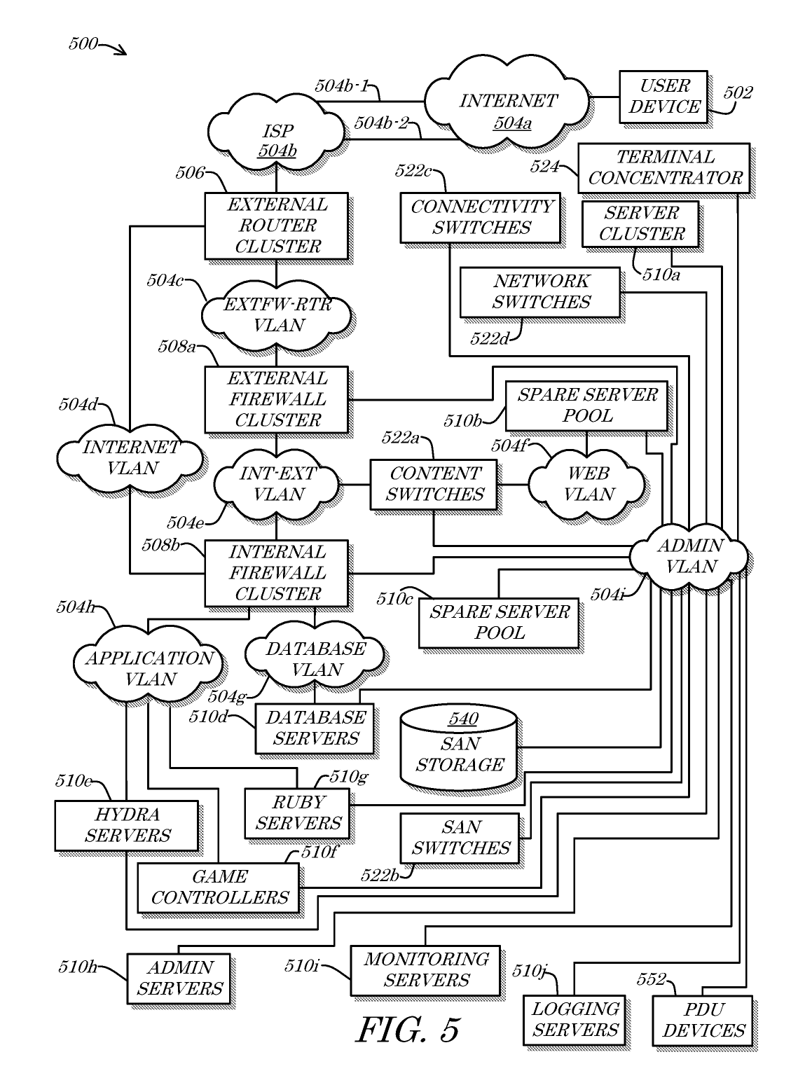

Referring now to FIG. 4, a block diagram of a system 400 according to some embodiments is shown. In some embodiments, the system 400 may comprise and/or define a “front-end” architecture of a gaming platform such as a platform via which social, multiplayer, and/or online games may be played (e.g., one or more automated communal blackjack games as described herein). The system 400 may be similar in configuration and/or functionality, for example, to the system 300 of FIG. 3 and/or one or more portions thereof. In some embodiments, the system 400 may comprise a user device 402, a plurality of networks (and/or environments and/or layers) 404a-j (e.g., the Internet 404a, a Distributed Denial-of-Service (DDoS) protection layer 404b, a primary transit provider layer 404c, a secondary transit provider layer 404d, a Pre-Production (PP) environment 404e, a live environment 404f, a LAN 404g, a backend environment 404h, a PP backend layer 404i, and/or a live backend layer 404j), a plurality of routers 406b-d, a plurality of firewall devices 408e-g, 408i-j, a plurality of servers 410e-f (e.g., a PP server cluster 410e and/or a live server cluster 410f), a plurality of switching devices 422a, 422e-f, 422i-j, a Terminal Concentrator (TC) 424f, a plurality of “hydra” services 430i-j (e.g., a PP hydra service 430i and/or live hydra service 430j), and/or a plurality of Power Distribution Unit (PDU) devices 452e-f.

According to some embodiments, any or all of the components 402, 404a-j, 406b-d, 408e-g, 408i-j, 410e-f, 422a, 422e-f, 422i-j, 424f, 430i-j, 452e-f of the system 400 may be similar in configuration and/or functionality to any similarly named and/or numbered components described herein. Fewer or more components 402, 404a-j, 406b-d, 408e-g, 408i-j, 410e-f, 422a, 422e-f, 422i-j, 424f, 430i-j, 452e-f (and/or portions thereof) and/or various configurations of the components 402, 404a-j, 406b-d, 408e-g, 408i-j, 410e-f, 422a, 422e-f, 422i-j, 424f, 430i-j, 452e-f may be included in the system 400 without deviating from the scope of embodiments described herein. While multiple instances of some components 404a-j, 406b-d, 408e-g, 408i-j, 410e-f, 422a, 422e-f, 422i-j, 430i-j, 452e-f are depicted and while single instances of other components 402, 424f are depicted, for example, any component 402, 404a-j, 406b-d, 408e-g, 408i-j, 410e-f, 422a, 422e-f, 422i-j, 424f, 430i-j, 452e-f depicted in the system 400 may comprise a single device, a combination of devices and/or components 402, 404a-j, 406b-d, 408e-g, 408i-j, 410e-f, 422a, 422e-f, 422i-j, 424f, 430i-j, 452e-f, and/or a plurality of devices, as is or becomes desirable and/or practicable. Similarly, in some embodiments, one or more of the various components 402, 404a-j, 406b-d, 408e-g, 408i-j, 410e-f, 422a, 422e-f, 422i-j, 424f, 430i-j, 452e-f may not be needed and/or desired in the system 400.

In some embodiments, the user device 402 may be utilized to access one or more of the PP environment 404e, the live environment 404f, and/or the backend environment 404h via the Internet 404a. In some embodiments, the user device 402 may be utilized to access the backend environment 404h and/or the PP hydra service 430i via the PP backend layer 404i. A PP backend switch device 422i and/or a PP backend firewall device 408i may, for example, gate and/or control access to the backend environment 404h and/or the PP hydra service 430i, via the PP backend layer 404i. In some embodiments, the user device 402 may be utilized to access the backend environment 404h and/or the live hydra service 430j via the live backend layer 404j. A live backend switch device 422j and/or a live backend firewall device 408j may, for example, gate and/or control access to the backend environment 404h and/or the live hydra service 430j, via the live backend layer 404j.

According to some embodiments, any communications (e.g., requests, calls, and/or messages) from the user device 402 may be passed through the DDoS protection layer 404b. The DDoS protection layer 404b may, for example, monitor and/or facilitate protection against various forms of cyber attacks including, but not limited to, DDoS attacks. In some embodiments, the DDoS protection layer 404b may comprise and/or be in communication with a plurality of DDoS router devices 406b-1, 406b-2, 406b-3, 406b-4 that may be utilized to route and/or direct incoming communications (e.g., from the user device 402) to appropriate portions of the system 400.

In some embodiments, the DDoS protection layer 404b and/or a first DDoS router device 406b-1 may route communications from the user device 402 through and/or via a first switch device 422a-1 and/or to, through, and/or via a first primary transit provider router device 406c-1. In some embodiments, the first switch device 422a-1 may comprise a device utilized for security switching such as may implement communications in accordance with the Generic Routing Encapsulation (GRE) communications tunneling protocol described in RFC 2784 “Generic Routing Encapsulation (GRE)” published by the Network Working Group (NWG) in March, 2000. The first primary transit provider router device 406c-1 may, for example, provide access to the PP environment 404e and/or the PP server cluster 410e thereof, such as via one or more PP firewall devices 408e-1, 408e-2 and/or one or more PP switch devices 422e-1, 422e-2. According to some embodiments, the PP switch devices 422e-1, 422e-2 may comprise content switching devices that process and route data (e.g., in the data link layer) based on data content. In some embodiments, the first primary transit provider router device 406c-1 may direct communications to, through, and/or via a PP LAN switch device 422e-3 that provides and/or facilitates access to the LAN 404g. The LAN 404g may, for example, provide private access to and/or between the PP environment 404e, the live environment 404f, and/or the backend environment 404h. In some embodiments, the first primary transit provider router device 406c-1 and/or the PP LAN switch device 422e-3 may direct communications to, through, and/or via a LAN firewall device 408g that provides direct access to either or both of the PP server cluster 410e and the live server cluster 410f.

According to some embodiments, the DDoS protection layer 404b and/or a second DDoS router device 406b-2 may route communications from the user device 402 through and/or via a second switch device 422a-2 and/or to, through, and/or via a first secondary transit provider router device 406d-1. In some embodiments, the second switch device 422a-2 may comprise a device utilized for security switching such as may implement communications in accordance with the GRE communications tunneling protocol. The first secondary transit provider router device 406d-1 may, for example, provide access to the live environment 404f and/or the live server cluster 410f thereof, such as via one or more live firewall devices 408f-1, 408f-2 and/or one or more live switch devices 422f-1, 422f-2. According to some embodiments, the live switch devices 422f-1, 422f-2 may comprise content switching devices that process and route data (e.g., in the data link layer) based on data content. In some embodiments, the first secondary transit provider router device 406d-1 may direct communications to, through, and/or via a live LAN switch device 422f-3 that provides and/or facilitates access to the LAN 404g. In some embodiments, the first secondary transit provider router device 406d-1 and/or the live LAN switch device 422f-3 may direct communications to, through, and/or via the LAN firewall device 408g that provides direct access to either or both of the PP server cluster 410e and the live server cluster 410f.

In some embodiments, the DDoS protection layer 404b and/or one or more of a third DDoS router device 406b-3 and/or a fourth DDoS router device 406b-4 may route communications from the user device 402 through and/or via one or more of the primary transit provider layer 404c and/or the secondary transit provider layer 404d. In some embodiments, a transit provider switch device 422a-3 may direct, swap, route, and/or manage communications between the primary transit provider layer 404c and the secondary transit provider layer 404d. According to some embodiments, the transit provider switch device 422a-3 may comprise a switching device that operates in accordance with an Exterior Border Gateway Protocol (EBGP)—e.g., the transit provider switch device 422a-3 may comprise one or more edge or border routers. In some embodiments, the first primary transit provider router device 406c-1, the first secondary transit provider router device 406d-1, a second primary transit provider router device 406c-2, and/or a second secondary transit provider router device 406d-2 may be utilized to route and/or direct communications between (i) the primary transit provider layer 404c and/or the secondary transit provider layer 404d and (ii) the PP environment 404e and/or the live environment 404f.

According to some embodiments, the PP server cluster 410e and/or the PP environment 404e may comprise various hardware, software, and/or firmware that permits a user (e.g., of the user device 402) to program, edit, manage, and/or otherwise interface with PP game elements and/or interfaces (e.g., for development and/or testing purposes). In some embodiments, the PDU devices 452e-1, 452e-2 may generally provide power distribution, supply, management, backup, and/or conditioning services (e.g., to the PP server cluster 410e) as is or becomes desired. According to some embodiments, additional switch devices 422e-4, 422e-5 may be utilized to distribute, balance, manage and/or control communications to, from, and/or within the PP server cluster 410e.

In some embodiments, the live server cluster 410f and/or the live environment 404f may comprise various hardware, software, and/or firmware that permits a user (e.g., of the user device 402) to program, edit, manage, and/or otherwise interface with live game elements and/or interfaces (e.g., for troubleshooting, corrective, and/or live environment management purposes). In some embodiments, the PDU devices 452f-1, 452f-2 may generally provide power distribution, supply, management, backup, and/or conditioning services (e.g., to the live server cluster 410f) as is or becomes desired. According to some embodiments, additional switch devices 422f-4, 422f-5 may be utilized to distribute, balance, manage and/or control communications to, from, and/or within the live server cluster 410f. In some embodiments, the TC device 424f may be utilized to manage communications from a variety of data sources such as by providing communication capability between various communications channels (not separately depicted in FIG. 4).

According to some embodiments, the user device 402 in conjunction with the live server cluster 410f (e.g., via the Internet 404a) may conduct (in whole or in part), facilitate, and/or otherwise be associated with execution of one or more stored procedures, applications, processes, and/or methods (e.g., the methods 600, 800 of FIG. 6 and/or FIG. 8 herein, and/or one or more portions thereof) as described herein. In some embodiments, the user device 402 in conjunction with the live server cluster 410f may conduct, or facilitate the execution of procedures, applications and processes that differ between different user devices 402 (not shown explicitly/separately in FIG. 4), creating different gaming experiences for the two users of these devices, even if playing the same game, in the same game session, etc.

Turning to FIG. 5, a block diagram of a system 500 according to some embodiments is shown. In some embodiments, the system 500 may comprise and/or define a “back-end” architecture of a gaming platform such as a platform via which social, multiplayer, and/or online games may be played (e.g., one or more automated communal blackjack games as described herein). The system 500 may be utilized in conjunction with the systems 300, 400 if FIG. 3 and/or FIG. 4 herein, for example, and/or may be similar in configuration and/or functionality to the backend environment 404h of the system 400 of FIG. 4. In some embodiments, the system 500 may comprise a user device 502, a plurality of networks (and/or environments and/or layers) 504a-i (e.g., the Internet 504a, an ISP 504b, an External Firewall-Router (EXTFW-RTR) Virtual LAN (VLAN) 504c, an Internet VLAN 504d, an Internal-External (INT-EXT) VLAN 504e, a web VLAN 504f, a database VLAN 504g, an application VLAN 504h, and/or an administrator VLAN 504i), an external router cluster 506, a plurality of firewall clusters 508a-b (e.g., an external firewall cluster 508a and/or an internal firewall cluster 508b), a plurality of servers 510a-j (e.g., a server cluster 510a, a first spare server pool 510b, a second spare server pool 510c, database servers 510d, “hydra” servers 510e, game controllers 510f, ruby servers 510g, admin servers 510h, monitoring servers 510i, and/or logging servers 510j), a plurality of switches 522a-d (e.g., content switches 522a, Storage Area Network (SAN) switches 522b, connectivity switches 522c, and/or network switches 522d), a TC device 524, a SAN storage device 540, and/or one or more PDU devices 552.

According to some embodiments, any or all of the components 502, 504a-l, 506, 508a-b, 510a-j, 522a-d, 524, 540, 552 of the system 500 may be similar in configuration and/or functionality to any similarly named and/or numbered components described herein. Fewer or more components 502, 504a-l, 506, 508a-b, 510a-j, 522a-d, 524, 540, 552 (and/or portions thereof) and/or various configurations of the components 502, 504a-l, 506, 508a-b, 510a-j, 522a-d, 524, 540, 552 may be included in the system 500 without deviating from the scope of embodiments described herein. While multiple instances of some components 504a-l, 508a-b, 510a-j, 522a-d are depicted and while single instances of other components 502, 506, 524, 540, 552 are depicted, for example, any component 502, 504a-l, 506, 508a-b, 510a-j, 522a-d, 524, 540, 552 depicted in the system 500 may comprise a single device, a combination of devices and/or components 502, 504a-l, 506, 508a-b, 510a-j, 522a-d, 524, 540, 552, and/or a plurality of devices, as is or becomes desirable and/or practicable. Similarly, in some embodiments, one or more of the various components 502, 504a-l, 506, 508a-b, 510a-j, 522a-d, 524, 540, 552 may not be needed and/or desired in the system 500.

In some embodiments, the user device 502 may be utilized to access and/or interface with one or more of the servers 510a-j via the Internet 504a. In some embodiments, the Internet 502a may be linked to the ISP 504b via multiple (e.g., redundant) connectivity paths 504b-1, 504b-2 (e.g., for load balancing, security, and/or failure recovery). According to some embodiments, the ISP 504b may be in communication with (and/or comprise) the external router cluster 506. The external router cluster 506 may route certain requests, calls, and/or transmissions (and/or users—e.g., based on credentials and/or other information) through the EXTFW-RTR VLAN 504c and/or through the external firewall cluster 508a, for example, and/or may route certain requests, calls, and/or transmissions (and/or users—e.g., based on credentials and/or other information) through the Internet VLAN 504d and/or through the internal firewall cluster 508b.

In the case that a user (not shown) of the user device 502 comprises an online game player, consumer, and/or other member of the public, for example, the external router cluster 506 may direct communications through the EXTFW-RTR VLAN 504c and/or through the external firewall cluster 508a. In the case that the user of the user device 502 comprises a programmer, tester, employee, and/or other agent of a game provider and/or other entity that operates the system 500, for example, the external router cluster 506 may direct communications through the Internet VLAN 504d and/or through the internal firewall cluster 508b. In some embodiments, access via either or both of the external firewall cluster 508a and/or the internal firewall cluster 508b may permit the user device 502 to communicate via the INT-EXT VLAN 504e. The INT-EXT VLAN 504e may, for example, provide access to the content switches 522a which may, in some embodiments, serve content from any or all of the servers 510a-j to the user device 502, as is or becomes appropriate or desired. In some embodiments, the content switches 522a may communicate with the first spare server pool 510b via the web LAN 504f.

According to some embodiments, private and/or other specialized access to the system 500 via the internal firewall cluster 508b may permit the user device 502 to communicate via one or more of the database VLAN 504g, the application VLAN 504h, and/or the admin VLAN 504i. The database VLAN 504g may be utilized, for example, to access and/or communicate with the database servers 510d. In some embodiments, the application VLAN 504h may be utilized to access and/or communicate with any or all of the hydra servers 510e, the game controllers 510f, and/or the ruby servers 510g.

The admin VLAN 504i may allow, promote, conduct, facilitate, and/or manage a wide variety of communications within the system 500. The admin VLAN 504i may, for example, communicatively connect and/or couple any or all of the firewalls 508a-b, the servers 510a-j, the switches 522a-d, the TC device 524, the SAN storage 540, and/or the PDU devices 552. The user device 502 may be utilized, in conjunction with the admin servers 510h and/or via the admin VLAN 504i for example, to define, edit, adjust, manage, and/or otherwise access settings (and/or data) of the firewalls 508a-b, any or all of the switches 522a-d, the TC device 524, and/or the PDU devices 552. In some embodiments, the user device 502 (and/or the admin servers 510h) may be utilized to manage and/or access content, rules, logic (e.g., auto play logic), settings, and/or performance characteristics or preferences for any or all of the servers 510a-j.

In some embodiments, the server cluster 510a may comprise one or more servers and/or other electronic controller devices (e.g., blade servers) configured to provide online gaming data (e.g., interfaces (such as the example interface 720 of FIG. 7A, FIG. 7B, and/or FIG. 7C herein), automated game play decisions, outcomes, and/or results) to the user device 502. According to some embodiments, the first spare server pool 510b and/or the second spare server pool 510c may comprise one or more server and/or other electronic controller devices configured to supplement and/or replace the server cluster 510a as needed and/or desired (e.g., to manage load and/or error recovery situations). In some embodiments, the database servers 510c may provide and/or manage access to stored data such as data stored in and/or by the SAN storage device 540. In some embodiments, the hydra servers 510e and/or the game controllers 510f may provide online game information such as interfaces, automatic game play decisions, outcomes, results, graphics, sounds, and/or other data or media to the user device 502 (e.g., via the application VLAN 504h). In some embodiments, the ruby servers 510g may comprise one or more processing devices configured to provide access to one or more programming languages (e.g., “Ruby”) and/or Application Programming Interface (API) mechanisms via which the servers 510a-j and/or other portions of the system 500 may be configured to operate (e.g., in accordance with specially and/or pre-programmed instructions written in the programming language and/or developed by the API provided by the ruby servers 510g). According to some embodiments, the admin servers 510h, the monitoring servers 510i, and/or the logging servers 510j may be utilized and/or configured to provide administrative, parameter and/or metric monitoring and/or reporting, and/or data logging and/or audit services, respectively.

According to some embodiments, the user device 502 in conjunction with one or more of the servers 510a-j (e.g., via the Internet 504a) may conduct (in whole or in part), facilitate, and/or otherwise be associated with execution of one or more stored procedures, applications, processes, and/or methods (e.g., the methods 600, 800 of FIG. 6 and/or FIG. 8 herein, and/or one or more portions thereof) as described herein. In some embodiments, the user device 502 in conjunction with one or more of the servers 510a-j may facilitate the execution of procedures, applications and processes that differ between different user devices 502 (not shown explicitly/separately in FIG. 5), creating different gaming experiences for two players, even if playing the same game, in the same game session, etc.

### III. Automated Communal Play Data Processing and Output

### A. Automated Communal Play Process

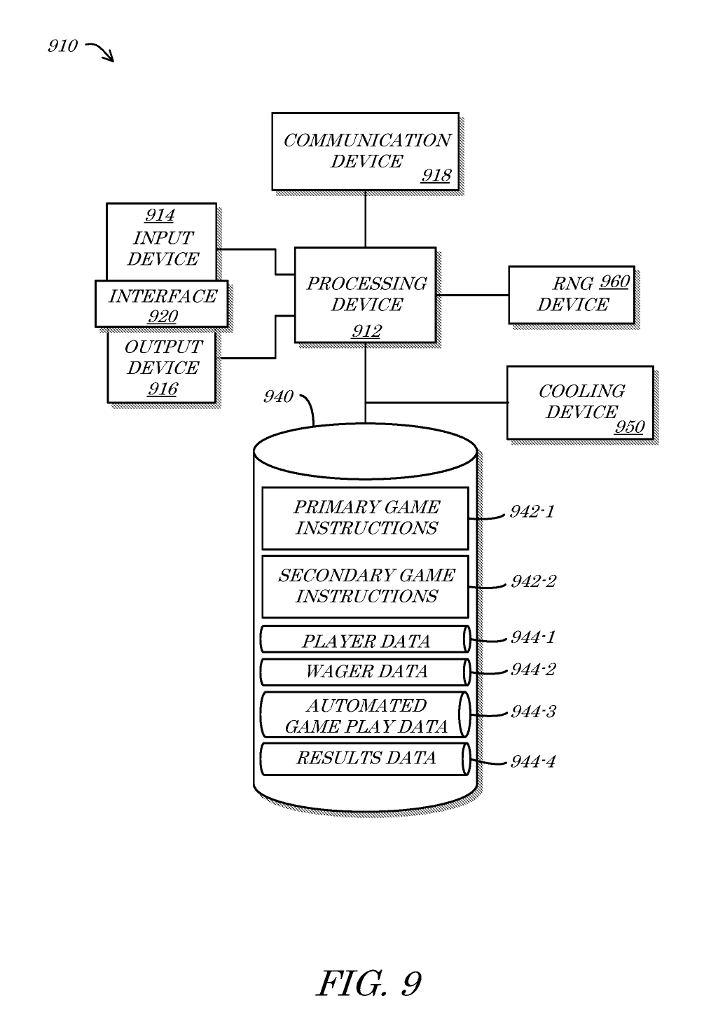

Referring now to FIG. 6, a flow diagram of a method 600 according to some embodiments is shown. In some embodiments, the method 600 may be performed and/or implemented by and/or otherwise associated with one or more specialized and/or computerized processing devices (e.g., the player and/or user devices 102a-n, 202a-n, 302a-b, 402, 502 and/or the servers, apparatus, and/or controller devices 110, 210a-n, 310a-g, 410e-f, 510a-j, 810, 910 of FIG. 1, FIG. 2, FIG. 3, FIG. 4, FIG. 5, FIG. 8, and/or FIG. 9 herein), specialized computers, computer terminals, personal or mobile devices, tablets, computer servers, kiosks, LCD or LED touch-screens, computer systems and/or networks, and/or any combinations thereof (e.g., by one or more online game providers and/or online gaming player processing devices). In some embodiments, the method 600 may be embodied in, facilitated by, and/or otherwise associated with various input mechanisms and/or interfaces (such as the example interface 720 of FIG. 7A, FIG. 7B, and/or FIG. 7C herein).

The process and/or flow diagrams described herein do not necessarily imply a fixed order to any depicted actions, steps, and/or procedures, and embodiments may generally be performed in any order that is practicable unless otherwise and specifically noted. In some embodiments, although a fixed order is not generally implied, the various components, steps, or procedures of a given method as disclosed herein may be specifically implemented in the order depicted and/or procedures, steps, or components shown following another procedure, step, or component may be performed and/or triggered in response to one or more previously-depicted and/or connected procedures, steps, or components. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

According to some embodiments, the method 600 may comprise outputting (e.g., by a processing device and/or via an output device and/or electronic communications network device) a blackjack game interface, at 602. The blackjack game interface (e.g., the interface 720 of FIG. 7A, FIG. 7B, and/or FIG. 7C herein) may, for example, be output or caused to be output by a transmittal of one or more interface initiation and/or configuration commands from a central server to a remote mobile device of a player. The commands may define or identify, for example, various graphical elements of the interface and/or information defining various positioning, formatting, and/or behavior characteristics of the elements. The transmitted commands may, for example, define how a blackjack table (e.g., a virtual table) should be displayed and/or populated on a particular screen of the remote mobile device. According to some embodiments, the outputting may comprise and/or be preceded or triggered by a signal received from the remote mobile device. The remote mobile device may transmit, and the central server device may receive for example, a signal defining or identifying parameters of the display of the remote mobile device, e.g., a device type (such as manufacturer, model, and/or serial number or, MAC address), a screen type, and/or screen characteristics such as pixel or other dimensions (e.g., actual physical pixels and/or rendered pixels, e.g., four hundred and fourteen by six hundred and twenty-eight (414×628) pixels, screen dimensions such as three by four (3×4) inches, or a diagonal screen measurement such as five and one half (5.5) inches diagonally). The interface components for rendering an image of the blackjack table or blackjack game interface elements may then, for example, be calculated or selected (e.g., from a pre-calculated set) to fit the given screen size/parameters. The commands transmitted back to the remote mobile device may then accordingly provide for an output of the interface that fits within the given “real estate” for the display device of the remote mobile device.

In some embodiments, the method 600 may comprise providing (e.g., by the processing device and/or via the electronic communications network device), a wagering opportunity, at 604. The interface output at 602, for example, may comprise one or more input components or elements (e.g., a virtual “wager” button) that allow a player to enter or define a wager for a particular session of a blackjack game. According to some embodiments, such as in the case of a “communal” blackjack game as described herein, the same or similar interface component may be output to a plurality of players (or potential players). In some embodiments, the input component and/or opportunity to wager may be provided for a limited, predefined, and/or otherwise defined time window (e.g., within five (5) minutes to one (1) minute prior to a scheduled initiation of an auto play blackjack game, and/or after one hundred (100) wagers have been received). A provided interface input component may only be active during a particular wagering time window, for example, and/or may only be output during the time window (e.g., may disappear or be removed from the interface when the time window closes). In some embodiments, the wagering opportunity may be the same for any or all potential participants. In the case that multiple “player” positions in an auto play blackjack game are depicted or provided, for example, a plurality of players of the auto play blackjack game may interface with the component provided to place wagers on the same “player” position (e.g., as opposed to standard blackjack play, where each actual player is associated with, controls, and/or places a wager on a unique or distinct “player” position/hand.

According to some embodiments, the method 600 may comprise receiving (e.g., by the processing device and/or via the electronic communications network device), wagers, at 606. An indication may be received from a player device and/or via a network, for example, such indication being descriptive of a desire of a particular player (e.g., identified by a particular player identifier and/or associated (e.g., uniquely) with a particular player account) to place a wager in or for an instance or session of an auto play communal blackjack game. In some embodiments, the indication may be received upon and/or in response to an activation of or interfacing with, by the player, an interface component provided (e.g., at 604) with respect to a wagering opportunity. Activation of the component by the player may, for example, cause a signal to be transmitted from a remote and/or mobile electronic player device utilized by the player, such signal being addressed and/or directed to the processing device (e.g., a gaming server). According to some embodiments, the signal may comprise an indication and/or definition of a wager amount, a player identifier (e.g., player account number, IP address, MAC address, etc.), a time stamp, and/or one or more designated or desired blackjack positions upon which the wager should be placed. In some embodiments, such as in the case that the wagering opportunity at 604 is provided during a limited window of time and/or wager counts (or sum of total amounts), any timestamp provided with the wager placement signal may be utilized to sort, identify, and/or filter wagers based on when they were placed by a player (e.g., as opposed to when they were received; e.g., to account for network latency issues).

In some embodiments, the method 600 may comprise generating (e.g., by the processing device) initial blackjack hands, at 608. The processing device may communicate with, control, and/or comprise, for example, a Random Number Generator (RNG) utilized to generate random (or pseudo-random) numbers that are mapped to various playing card values and/or suits. According to some embodiments, the RNG may be activated to generate initial blackjack card play hands for each of the provided “player” positions (e.g., two (2) cards), as well as for the dealer (e.g., a single card or a single “face-up” card and a single “face-down” card). According to some embodiments, the wager placement(s) may occur subsequent to the generation and/or display of the initial hands. In some embodiments, a first round or initial wager(s) may be placed prior to the generating of the initial hands, e.g., each actual player of the auto play blackjack game may wager on one or more game/“player” positions prior to initial hands being generated and/or may wager (e.g., a second round or second wager) once the initial hands are generated and/or displayed.

According to some embodiments, the method 600 may comprise computing (e.g., by the processing device) automated game play decisions, at 610. Stored rules and/or logic may be accessed and/or initiated (e.g., by the processing device), for example, to operate on input variables (e.g., initial hand cards) to compute game play moves or decisions. In accordance with Table 1 described herein, for example, the processing device may access a data storage device storing logic or rules in accordance with “perfect” play blackjack game play strategies of Table 1 to determine, based on one or more of the initial hands (generated at 608), an appropriate responsive game play action. In some embodiments, game play decisions may be computed for each “player” position and the dealer position. In some embodiments, different logic may be applied different player positions/hands (e.g., one set of rules for the dealer and one set for the “player” positions, or different logic for different “player” positions). As described herein, the computing of the game play decisions may be conducted on behalf of or in place of player game input(s). The computing at 610 may, for example, comprise an “auto play” logic that enables a communal blackjack game to proceed with only wager input received from real human players (i.e., in the absence of human player game play decision input).

In some embodiments, the method 600 may comprise implementing (e.g., by the processing device) the automated game play decisions, at 612. In accordance with the rules for the given game (e.g., blackjack), for example, the processing device may execute the computed game play decisions from 610. In the case that it is determined at 610 that a given hand (e.g., at a given position) should be “hit”, for example, a call may be placed in the blackjack game for an extra card to be dealt for that hand. In some embodiments, “hit”, “stand”, “double”, “split”, and/or “surrender” game play actions may be implemented (e.g., based on automatically computed game play decisions at 610) for each hand position in the automatic communal blackjack game.

According to some embodiments, the method 600 may comprise generating final blackjack hands, at 614. As with generation of the initial hands at 608, for example, an RNG may be utilized to determine random cards as-needed. In the case that a gem play decision was computed to be a “hit”, for example, an additional card may be randomly determined and added to that particular hand. For hands/positions not requiring additional cards (e.g., in the case that the automatically computed game play decision resulted in a “stay”), the generation at 614 may not be required.

In some embodiments, the method 600 may comprise computing (e.g., by the processing device) game outcomes, at 616. In accordance with game rules (e.g., the same rule set implemented at 612), for example, each hand/position may be evaluated to determine a blackjack outcome. Individual card values for each hand/position may be summed, for example, to determine a total hand/position value. In some embodiments, any hand values of twenty-one (21) or lower may be ranked in order from highest to lowest, with hand values above twenty-one (21) being discarded, disqualified, or tagged as a “bust”. According to some embodiments, the ranked and/or sorted hands may be evaluated to determine one or more game results. The “player” positions may typically be compared to the dealer position, for example, to determine whether any particular “player” position is a winner. Any winning hands/positions may be evaluated to determine a corresponding result, e.g., based on any placed wagers.

According to some embodiments, the method 600 may comprise outputting (e.g., by the processing device and/or via an output device and/or electronic communications network device) game results, at 618. An interface provided to an individual player of the automated communal blackjack game may, for example, be updated to include an indication of a result for that particular player. In some embodiments, the outcome(s) computed at 616 may also or alternatively be output. In the case that a player utilized a mobile and/or remote electronic device to participate in (i.e., place one or more wagers in) the automatic communal blackjack game, the processing device may transmit a signal causing a display device of the player's device to output the result(s)/outcome(s). The outputting may comprise, for example, transmitting one or more commands (and/or data items, such as data defining one or more graphical interface elements) from the central server device to the remote mobile player device.

### B. Automated Communal Play Interfaces

Turning now to FIG. 7A, FIG. 7B, and FIG. 7C, an example interface 720 according to some embodiments is shown. In some embodiments, the interface 720 may comprise one or more of a web page, web form, database entry form, API, spreadsheet, table, and/or application or other GUI via which a player may interact with (e.g., place a wager in) an automated communal blackjack game as described herein. The interface 720 may, for example, comprise a front-end of an online, social, network, and/or wagering game program (and/or portion thereof) and/or platform programmed and/or otherwise configured to execute, conduct, and/or facilitate the methods 600, 800 of FIG. 6 and/or FIG. 8 herein, and/or one or more portions and/or combinations thereof. In some embodiments, the interface 720 may be output via a computerized device (e.g., a processor or processing device) such as one or more of the player and/or user devices 102a-n, 202a-n, 302a-b, 402, 502, 802 and/or the servers, apparatus, and/or controller devices 110, 210a-n, 310a-g, 410e-f, 510a-j, 810, 910 of FIG. 1, FIG. 2, FIG. 3, FIG. 4, FIG. 5, FIG. 8, and/or FIG. 9 herein. In some embodiments, the example interface 720 may comprise interface outputs of (and/or otherwise associated with) a GUI utilized to conduct and/or play an automated communal blackjack game, such as may be implemented and/or provided as described herein. In some embodiments, the interface 720 may be output as part of a game play system.

In accordance with some embodiments, for example, a system for facilitating an electronic and/or automated game of blackjack may comprise a blackjack game server which includes a processor and a memory storing rules for blackjack play. The processor may, in accordance with some embodiments, be operable with the program to (i) output an interface for a blackjack game comprising a dealer station and at least one player position; (ii) output an opportunity for a plurality of players to join the blackjack game by placing wagers on the at least one player position; (iii) receive an indication that the plurality of players are placing wagers on the at least one player position; (iv) output an end to the opportunity for the plurality of players to place wagers on the at least one player position; (v) generate a dealer's initial hand at the dealer's station, and a players' initial hand at the at least one player position; (vi) determine in communication with the memory storing rules for automated blackjack play, and in light of the dealer's initial hand and the players' initial hand, a strategy concerning how to play the players' initial hand; (vii) generate automated game play decisions based on the strategy concerning how to play the players' initial hand; (viii) generate a players' final hand and a dealer's final hand based on the automated game play decisions; (ix) determine resolution of the blackjack game based on the players' final hand and the dealer's final hand; and (x) determine at least one result of the placed wagers of the plurality of players.

In some embodiments, the interface 720 of FIG. 7A, FIG. 7B, and FIG. 7C, may comprise an an example game interface 720 as it may be modified over the course of a particular game session or event upon which one or more players may wager (e.g., dealing and resolution of multiple player hands and a dealer hand in an automated communal blackjack game). The game event represented by the interface 720 may comprise a game event of a game of blackjack comprising automated communal play in accordance with embodiments described herein. In the present application, like reference numerals in the Figures refer to like elements. Thus, for example, the game interface 720, although it may display different data (e.g., different cards dealt to the various player positions or a result of the game event upon the resolution of the dealer hand and the player hands) as the game event progresses, is consistently referred to as game interface 720 in each of FIG. 7A, FIG. 7B, and FIG. 7C.

The concepts of automated communal blackjack play may be implemented using an electronic representation of a blackjack table such as table 722 (which is illustrated in FIG. 7A, FIG. 7B, and FIG. 7C, with appropriate data modifications to show progression of an example game event). Although in accordance with some embodiments, automated communal play of blackjack may be offered as an electronic game (e.g., an online game) and FIG. 7A, FIG. 7B, and FIG. 7C illustrate an electronic version of such a blackjack game, in other embodiments automated communal play may be implemented on a physical blackjack table which may be laid out in a manner similar to that shown in FIG. 7A, FIG. 7B, and FIG. 7C.

According to some embodiments, the blackjack table 722 may have a planar top surface 722-1 (which may comprise a virtual representation of a planar top surface, such as would be planar to a surface of a display screen outputting the interface 720). In some embodiments, a dealer station 724 may be positioned on one side of the blackjack table 722. The dealer station 724 may comprise, in some embodiments, an area of the game interface 720 in which a virtual dealer (not shown) may be represented (in the case of an electronic game or an electronic table) and in which elements associated with a dealer may be represented. For example, the dealer station area 724 may comprise a chip rack 724-1 (which may comprise a virtual representation of a chip rack, in the case of an electronic game), and a dealer hand area 724-2. Note that not all of these elements are necessary for a dealer station 724. Likewise, additional elements, or repositioning of elements, are contemplated as being within the scope of the present disclosure. For example, an element which indicates a visual alert (not shown) when the dealer is dealt a natural blackjack (i.e., when a dealer's hand consists of an ace and any ten (10) point card) could be added.

In some embodiments, the chip rack 724-1 may display representations of various virtual chips. Chips may be removed from the chip rack 724-1 to pay winning wagers and collected chips may be added to the chip rack 724-1 as losing wagers are collected. This movement of chips may all be represented graphically on game interface 720 as the blackjack game progresses to resolution. In some embodiments, an RNG may be used to determine the cards dealt for a hand in a blackjack game while in other embodiments a card shoe (virtual or physical) may be used and/or represented.

According to some embodiments, a discard collection area 726 may be used to collect and/or display virtual representations of used and/or collected cards after completion of a hand. Other discard collection mechanisms, or graphical displays thereof, are possible without departing from the scope of the present disclosure.

In some embodiments, the dealer hand area 724-2 is an area in which the cards representing the dealer's hand are displayed. In accordance with some embodiments, one of the cards dealt to a dealer's hand may be dealt face down, such that the value of the hand is not output or visible to the players. For purposes of the examples illustrated in FIG. 7A, FIG. 7B, and FIG. 7C, each of the cards dealt to a dealer's hand are illustrated as face up, for ease of describing a value of a dealer's hand versus a value of the players' hand. According to some embodiments, a message area 728 may be used to output or indicate information relevant to a game event being resolved. For example, in one embodiment message area 728 may output a current wagering strategy or game play decision strategy being employed to determine whether another card should be added to a player position hand (e.g., a table such as Table 1 herein may be output, and the relevant row or column of the table may be highlighted to draw the players' attention to the particular strategy being employed at a given time). In other embodiments, message area 728 may be utilized to output other information, such as whether players may currently join a game play event (or whether betting is currently closed because the result of the game play event is being determined), a total amount of wagers placed on the current game play event, a total number of players who have wagered or are participating in the current game play event, the minimum and maximum bet amount being accepted for a current game play event, as well as any other rules or other indicia particular to the blackjack game being played on the table 722.

According to some embodiments, a plurality of player positions 730a, 730b, and 730c may be represented within the representation of the table 722, e.g., on a curved side opposite the dealer station 724. Each player position 730a-c (collectively player positions 730 and, if no particular player position is being referred to, each as simply a player position 730) may comprise a respective area into which cards for each respective player position hand are dealt. In some embodiments, each player position 730 may not be associated with a single particular player for a particular game event in a traditional sense (e.g., the cards that are dealt to or displayed in a particular player position 730 are not cards dealt for a particular player such that the particular player makes game play decisions based on such cards). Rather, the player positions 730 represent individual player position hands but actual (e.g., human) players who wager on the game event being conducted are wagering, in accordance with at least some embodiments, on one or more (or all) of the player position hands being dealt and resolved in the player positions 730. As described herein, a player who wagers on the game event which includes resolution of a plurality of player position hands is wagering on each of the respective player position hands and any payout won by the player may, in accordance with some embodiments, be dependent on each of the final hands dealt to the respective player positions 730 for the game event.

A display on which the game interface 720 may be output may comprise a touch screen display and/or have associated input elements such as a keypad or keyboard. In some embodiments a game interface such as game interface 720 may additionally output information about one or more players wagering on a game event being output on the game interface, total wagers placed by a plurality of players on the game event, whether the game event is currently available for wagering on (or whether betting on the game event has closed, such as once cards are determined or dealt for at least one of the hands comprising the game event), the wager amount required to participate in the game event or other as described herein. In some embodiments, all players wagering on a particular game event may have output to them, via the game interface 720, the same information regarding the game event. In some embodiments, at least some of the information output via a game interface 720 may be customized for the particular player to whom the information is being output. For example, if player “A” and player “B” (e.g., first and second players) both wager on the same game event via their respective player devices (e.g., their mobile smart phones or PCs), the players may see the same cards being dealt to the dealer station and each of the player positions 730 of the game interface 720 but a credit balance or player identifier that is particular to each player may also be displayed via the game interface 720 and may be different for each of the players based on their personal information. In other words, in some embodiments, the game interface 720 may be displayed on separate, private, and/or individual video displays, for example, on personal electronic devices, such as a smart phone, hand held device, or laptop computer. Appropriate indicia may be used to distinguish what information relates to which players, and what information should be displayed on a player's individual video display. The display may be a touch screen display or include a keyboard, keypad or other user interface as desired. As described, information additional to what is illustrated in FIG. 7A, FIG. 7B, and FIG. 7C may be output to the players via a game interface 720, which additional information is omitted herein for purposes of brevity. For example, available funds or credits for betting, session information, player history or preferences, community cards available to all players participating in the game, information about other games the player is participating in, etc. may be show for one or more players.

Referring now to FIG. 7A in particular, illustrated therein is a screen shot of game interface 720 showing a “snapshot in time” taken during game play, at a time when a game event is still open for betting (i.e., the player position hands have not yet begun to be resolved and players may join the communal wagering game event by placing a wager). Accordingly, message area 728 is depicted as outputting an indication to players that they may join the game event by placing a wager. In accordance with some embodiments, placing the wager comprises placing a wager on all three (3) player positions 730a-c. In other embodiments a different number of player positions may be wagered upon, even by different players, and the embodiments described herein are not dependent on any particular number of player positions or player positions wagered upon. In accordance with some embodiments, a wager for the game event is specified by the system (e.g., message area 728 of FIG. 7A specifies a wager of thee dollars ($3)). In other embodiments, a player may be able to specify or customize a wager for the game event. In some embodiments, a wager placed by a player on a game event may be distributed evenly among the player positions 730a-c (e.g., one dollar ($1) of three dollars ($3) on each of the three (3) player positions 730a-c of FIG. 7A). In some embodiments, a wager on the game event may not be allocated equally among the player positions 730a-c (e.g., a player may distribute a wager among the player positions 730a-c based on preference).

Turning now to FIG. 7B, illustrated therein is a exemplary screen shot of the game interface 720 of FIG. 7A at a subsequent time, after betting has closed for the game event (as indicated in message area 728) and initial cards have been dealt to each of the player positions 730 and the dealer station 724. Illustrated is a first initial set of cards 732a in a first player position 730a, a first initial set of cards 732b in a second player position 730b, a third initial set of cards 732c at a third player position 730c, and an initial set of dealer cards 734 at dealer station 724.

In this example, the exemplary dealer's initial hand 734 is shown to comprise a two (2) of hearts, and a three (3) of diamonds. The player positions 730a, 730b and 730c are shown to comprise the following respective exemplary players' initial hands: 732a is shown to comprise a five (5) of clubs and a seven (7) of spades; 732b is shown to comprise an ace of hearts and an eight (8) of clubs; and 732c is shown to comprise an eight (8) of hearts and an eight (8) of spades. Variations on the dealer's and players' initial hands 732a-c, 734, rules concerning how to play these and other hands, and the structure and arrangement of the various elements on the game interface 720 are contemplated and embraced by the present disclosure.

Rules and strategies concerning how to play the exemplary initial hands 732a-c, 734 illustrated in FIG. 7B may be automatically implemented through the automated communal mode of one or more embodiments of the present invention. For example, in some embodiments, rules and strategic implementation of these rules (e.g., Optimal Game Play Decisions, as shown in Table 1) which aim to maximize the rate of return for players may control how a particular hand or hands are played. These rules and strategies may be stored in a database and implemented by a processor or a game server.

In one or more embodiments rules and strategies concerning blackjack play may be chosen from rules that maximize returns to players. For example, depending on the initial hand dealt to the dealer station and the initial hand dealt to a given player position, the rules programmed into the automated communal mode may direct a processor to automatically hit, stand, or split as a strategy employed to maximize the players' odds of winning a given hand. In one or more embodiments, fully automated rules, such as Optimal Game Play Decisions (e.g., such as those shown in Table 1) may be employed by the game server such that the players' odds of winning are maximized. As described, the user interface 720 may display (e.g., in the message area 728 or elsewhere) the specific strategies that the automated communal mode blackjack is employing for playing particular hands, which may, in turn, provide a helpful tutorial for players to learn and understand how to play blackjack, and may encourage players to play blackjack more frequently. In some embodiments, in addition to placing a wager, a player may be permitted to provide input regarding which automated rules/logic are to be employed in the game. In one embodiment, for example, all players having placed a wager may vote on a desired automated play logic rules set, with the one rule set from a plurality of available rules sets receiving the most votes being selected as the automated play rule set that will be employed in the particular gaming session.

FIG. 7C illustrates an exemplary screen shot, taken during game play and after the screenshot illustrated by FIG. 7B, showing the resolution of the game illustrated in FIG. 7B. In accordance with some embodiments, automated rules employing optimal blackjack strategy, in this case, the exemplary Optimal Game Play Decisions for Blackjack (see Table 1) were employed to make automated game play decisions based on each initial hand 732a-c, 734 at each player position 730a-c and at dealer station 724, thus generating final hands 736a-c, 738 for each player position 730a-c and the dealer station 724, as depicted in FIG. 7C.

For example, an exemplary first final hand 736a at the first player position 730a shows that the exemplary Optimal Game Play Decisions (see Table 1, corresponding to “Hard totals”=12 and “Dealer's face-up card”=2) required the automated decision to “hit” based on the cards initially dealt, at 732a (a five (5) of clubs and a seven (7) of spades, having a combined value of 12), to the first player position 730a in FIG. 7B. According to the exemplary Optimal Game Play Decisions for Blackjack, the decision to “hit” on an initial hand having the combined value of twelve (12) is statistically the best decision when the dealer's face-up card (assuming, for purposes of the description of this example, the dealer's second card is hidden from the players' view) is a two (2). As can be seen in the first final hand 736a, the next card dealt to the first player position 730a was an ace of diamonds, providing a total value of either twenty-two (22; if the ace has a value of eleven (11)) or thirteen (13; if the ace has a value of one (1)). Since the first player position 730a final hand 736a either busts (at a combined value of twenty-two (22)), or has a value otherwise less than the dealer's final hand 738 (comprising a two (2) of hearts, three (3) of diamonds, and a king of diamonds, having a combined value of fifteen (15)), the first player position 730a final hand 736a is an example of a losing hand.

According to the exemplary Optimal Game Play Decisions, the best way to play the second initial hand 732b at the second player position 730b in FIG. 7B was to “stay”, given that the dealer's initial hand 734 included a face up two (2) (see Table 1, corresponding to “Soft totals”=A,8-A,9 and “Dealer's face-up card”=2). As depicted in FIG. 7C, automated communal play successfully utilized this strategy as the combination of the ace (value eleven (11)) and the eight (8) (thus providing a combined value of nineteen (19)) of the second final hand at 736b defeats the dealer's final hand 738 having a combined value of fifteen (15).

The pair of eights (8) depicted in the third initial hand 732c in FIG. 7B was best “split” according to the exemplary Optimal Game Play Decisions of Table 1 (see Table 1, corresponding to “Pairs”=8, 8 and “Dealer's face-up card”=2). Accordingly, as depicted in FIG. 7C by the third final hand 736c for the split, at 736c-1 and 736c-2, automated play using this strategy resulted in one third final hand, 736c-1, comprising an eight (8) of hearts, a six (6) of clubs, and nine (9) of clubs, going over twenty-one (21; thus being a “bust”), and another third final hand, 736c-2, comprising an eight (8) of spades and a jack of diamonds, having a combined value of eighteen (18), defeating the dealer's final hand 738 with a combined value of fifteen (15).

According to some embodiments, the resolution of a blackjack game, including winning hands, disbursements of wagers, and other blackjack game outcomes, may be determined, for example, by a game server or a software program running on a player device, and displayed on a screen via the interface 720 as depicted in FIG. 7C. For example, in some embodiments, a graphical representation of the term “WINNER” may be prominently displayed over winning hands 736b and 736c-2. In one or more embodiments, blackjack game outcomes may also be displayed in message area 728, as depicted in FIG. 7C, congratulating players placing winning wagers at the second player position 730b and the third player position 730c (which may, as described herein, comprise more than two (2) actual players).

While various components of the example interface 720 have been depicted with respect to certain labels, layouts, headings, titles, graphics, and/or configurations, these features have been presented for reference and example only. Other labels, layouts, headings, titles, and/or configurations may be implemented without deviating from the scope of embodiments herein. Similarly, while a certain number of tabs, information screens, form fields, buttons, and/or data entry options have been presented, variations thereof may be practiced in accordance with some embodiments.

### C. Automated Communal Play Data Processing

Referring now to FIG. 8, a programmatic flowchart of a data processing method 800 according to some embodiments is shown. The data processing method 800, in accordance with some embodiments, may comprise transfer, transmittal, passing, exchanging, and/or providing of data between one or more of a mobile device 802 and a server device. As depicted in FIG. 8, the server device 810 may comprise a processing unit 812 that, upon initiation of a request (not shown) for example, may transmit interface commands at 860-1 to the mobile device 802 to cause a display device 816 of the mobile device 802 to display graphical representations associated with play and/or entry into an automated communal blackjack game as described herein. According to some embodiments, the interface commands and/or instructions may be defined by data stored in a memory 840 of the server device 810. The memory 840 may store, for example, interface instructions 842a that define how the gaming interface should be output on the display device 816.

In some embodiments, the interface output by the display device 816 may comprise an interactive and/or input element “1”, such as a GUI button or entry field. The input element “1” may, for example, comprise a graphical element that accepts wager input from a user (e.g., a player) of the mobile device 802. According to some embodiments, as described herein, the input element “1” may be active and/or output for a limited amount of time or during a specific window of availability “A” (e.g., within a predetermined cut-off time from game start, only available to the first thousand (1,000) wagers, only available for one (1) minute after being initiated, etc.). In some embodiments, the input element “1” may be triggered by the player to send a wager to the serve device 810, at 860-2.

According to some embodiments, as depicted, the wager 860-2 may be transmitted and/or routed to game instructions 842b stored in the memory 840 of the server device 810. Also as depicted via dotted lines, the initiation of the interface at 860-1 may, in some embodiments, be directed by and/or include activation or execution of the game instructions 842b. In some embodiments, the game instructions 842b may comprise programmed instructions defining all or part of an automated communal play blackjack game as described herein. According to some embodiments, the game instructions 842b may receive the wager 860-2 and may initiate (e.g., in response thereto) a call 860-3 to an RNG 860. The call 860-3 may, in some embodiments, be passed through, managed, and/or processed by the processing unit 812. According to some embodiments, the call 860-3 may be routed or transmitted directly to a stand-alone RNG 860 or an RNG 860 integrated into the processing unit 812.

The RNG 860, in response to the call 860-3, may generate one or more random numbers defining initial blackjack hands and may transmit indications of such initial outcomes to the game instructions 842b (and/or to or through the processing unit 812). According to some embodiments, the game instructions 842b may pass indications of the initial hands to the interface instructions 842a for outputting via the display device 816. In some embodiments, the game instructions 842b may utilize the initial hands/outcomes to process auto play logic 842c. Auto play logic 842c such as the rules defined by Table 1 herein, for example, may be accessed, consulted, and/or processed to accomplish game play in the absence of player game play input. The game instructions 842b, for example, may pass the initial hands/outcomes to the auto play logic 842c, at 860-5. The auto play logic 842c may process the received initial hands/outcome data to compute one or more game play decisions (e.g., “stay”, “hit”, etc.). The auto play logic 842c may pass the computed decisions to the game play instructions 842b at 860-6, much as a player would if a player were allowed to make game play decisions in the game (which, for automated play communal blackjack, they are not). In some embodiments, the game play decision(s) 860-6 may be passed by the game instructions 842b to the interface instructions 842a for outputting by the display device 816.

According to some embodiments, the auto play game play decision(s) from 860-6 may be processed and/or executed by the game instructions 842b. Upon implementation of such decisions, should any additional outcomes be desired or required (e.g., additional cards for a “hit” decision), the game instructions 842b may execute a second RNG call at 860-7. The RNG 860, in response to the call 860-7, may generate one or more random numbers defining final blackjack hands and may transmit indications of such final outcomes to the game instructions 842b (and/or to or through the processing unit 812). According to some embodiments, the game instructions 842b may pass indications of the final hands to the interface instructions 842a for outputting via the display device 816. In some embodiments, the game instructions 842b may utilize the final hands/outcomes to compute one or more game outcomes, at 860-9. It may be determined by application of game play rules executed by the game instructions 842b, for example, that one or more final hands (e.g., for one or more game play positions) may be winning hands (or losing hands, as the case may be).

In some embodiments, indications of the game outcome(s) may be passed to the interface instructions 842a for outputting via the display device 816. According to some embodiments, the game instructions 842b may compute one or more game results at 860-10. The final outcomes and/or game outcome(s) may, for example, be utilized in conjunction with other game play and/or player data such as individual player wager amounts, to determine any win (or loss) amounts attributable to each player that wagered in the automated play communal blackjack session. In some embodiments, indications of the game results may be passed to the interface instructions 842a for outputting via the display device 816. In such a manner, for example, once the wager is placed at 860-2, a player utilizing the mobile device 802 may be made aware of game play progress, decisions, outcomes, and/or results, while only having provided the initial wager as input to the automated play communal blackjack game server device 810.

### IV. Automated Communal Play Apparatus and Articles of Manufacture

Referring now to FIG. 9, a block diagram of an apparatus 910 according to some embodiments is shown. In some embodiments, the apparatus 910 may be similar in configuration and/or functionality to any of the player and/or user devices 102a-n, 202a-n, 302a-b, 402, 502 and/or the servers and/or controller devices 110, 210a-n, 310a-g, 410e-f, 510a-j, 810 of FIG. 1, FIG. 2, FIG. 3, FIG. 4, FIG. 5, and/or FIG. 8 herein, and/or may otherwise comprise a portion of the systems 100, 200, 300, 400, 500 and/or the methods 600, 800 of FIG. 1, FIG. 2, FIG. 3, FIG. 4, FIG. 5, FIG. 6, and/or FIG. 8 herein. The apparatus 910 may, for example, execute, process, facilitate, and/or otherwise be associated with the methods 600, 800 of FIG. 6 and/or FIG. 8 herein, and/or one or more portions and/or combinations thereof. In some embodiments, the apparatus 910 may comprise a processing device 912, an input device 914, an output device 916, a communication device 918, an interface 920, a memory device 940 (storing various programs and/or instructions 942 and data 944), a cooling device 950, and/or a Random Number Generator (RNG) 960. According to some embodiments, any or all of the components 912, 914, 916, 918, 920, 940, 942, 944, 950, 960 of the apparatus 910 may be similar in configuration and/or functionality to any similarly named and/or numbered components described herein. Fewer or more components 912, 914, 916, 918, 920, 940, 942, 944, 950, 960 and/or various configurations of the components 912, 914, 916, 918, 920, 940, 942, 944, 950, 960 be included in the apparatus 910 without deviating from the scope of embodiments described herein.

According to some embodiments, the processing device 912 may be or include any type, quantity, and/or configuration of electronic and/or computerized processor that is or becomes known. The processing device 912 may comprise, for example, an Intel® IXP 2800 network processor or an Intel® XEON™ Processor unit coupled with an Intel® E7501 chipset. In some embodiments, the processing device 912 may comprise multiple inter-connected units, processors, microprocessors, and/or micro-engines. According to some embodiments, the processing device 912 (and/or the apparatus 910 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 910 comprises a server such as a blade server, necessary power may be supplied via a standard AC outlet, power strip, surge protector, a PDU, and/or Uninterruptible Power Supply (UPS) device.

In some embodiments, the input device 914 and/or the output device 916 are communicatively coupled to the processing device 912 (e.g., via wired and/or wireless connections and/or pathways) and they may generally comprise any types or configurations of input and output components and/or devices that are or become known, respectively. The input device 914 may comprise, for example, a keyboard that allows an operator of the apparatus 910 to interface with the apparatus 910 (e.g., by a player, such as to place a wager in an automated communal play blackjack game as described herein). In some embodiments, the input device 914 may comprise a sensor configured to provide information such as player input (e.g., player wager definitions) to the apparatus 902 and/or the processing device 912. The output device 916 may, according to some embodiments, comprise a display screen and/or other practicable output component and/or device. The output device 916 may, for example, provide the interface 920 to a player (e.g., via a website, electronic communications network device, and/or non-authorized software application; e.g., the interface 720 of FIG. 7A, FIG. 7B, and/or FIG. 7C herein). According to some embodiments, the input device 914 and/or the output device 916 may comprise and/or be embodied in a single device such as a touch-screen monitor (e.g., a device capable of both receiving input and providing output; e.g., via the interface 920).

In some embodiments, the communication device 918 may comprise any type or configuration of communication device that is or becomes known or practicable. The communication device 918 may, for example, comprise a Network Interface Card (NIC), a telephonic device, a cellular network device, a router, a hub, a modem, and/or a communications port or cable. In some embodiments, the communication device 918 may be coupled to provide data to a remote device (not shown in FIG. 9), such as in the case that the apparatus 910 is utilized to provide the interface 920 to a player as a client-side application of an online wagering game hosted by a remote server, as described herein. The communication device 918 may, for example, comprise a cellular telephone network transmission device that receives (and/or sends) signals indicative of game interface components to customer and/or subscriber handheld, mobile, and/or telephone device, e.g., from a remote server device. According to some embodiments, the communication device 918 may also or alternatively be coupled to the processing device 912. In some embodiments, the communication device 918 may comprise an IR, RF, Bluetooth™, NFC, and/or Wi-Fi® network device coupled to facilitate communications between the processing device 912 and another device (such as a third-party device, not shown).

The memory device 940 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 940 may, according to some embodiments, store one or more of primary game instructions 942-1, secondary (e.g., bonus) game instructions 942-2, player data 944-1, wager data 944-2, automated game play data 944-3, and/or results data 944-4. In some embodiments, the primary game instructions 942-1, secondary game instructions 942-2, player data 944-1, wager data 944-2, automated game play data 944-3, and/or results data 944-4 may be utilized by the processing device 912 to provide output information via the output device 916 and/or the communication device 918.

According to some embodiments, the primary game instructions 942-1 may be operable to cause the processing device 912 to process player data 944-1, wager data 944-2, automated game play data 944-3, and/or results data 944-4. Player data 944-1, wager data 944-2, automated game play data 944-3, and/or results data 944-4 received via the input device 914 and/or the communication device 918 may, for example, be analyzed, sorted, filtered, decoded, decompressed, ranked, scored, plotted, and/or otherwise processed by the processing device 912 in accordance with the primary game instructions 942-1. In some embodiments, player data 944-1, wager data 944-2, automated game play data 944-3, and/or results data 944-4 may be fed by the processing device 912 through one or more mathematical and/or statistical formulas and/or models in accordance with the primary game instructions 942-1 to provide an online or electronic casual or wagering game, such as an online automated communal blackjack game, in accordance with embodiments described herein.

In some embodiments, the secondary game instructions 942-2 may be operable to cause the processing device 912 to process player data 944-1, wager data 944-2, automated game play data 944-3, and/or results data 944-4. Player data 944-1, wager data 944-2, automated game play data 944-3, and/or results data 944-4 received via the input device 914 and/or the communication device 918 may, for example, be analyzed, sorted, filtered, decoded, decompressed, ranked, scored, plotted, and/or otherwise processed by the processing device 912 in accordance with the secondary game instructions 942-2. In some embodiments, player data 944-1, wager data 944-2, automated game play data 944-3, and/or results data 944-4 may be fed by the processing device 912 through one or more mathematical and/or statistical formulas and/or models in accordance with the secondary game instructions 942-2 to provide an online or electronic casual or wagering game in addition to a base or primary game (e.g., a primary automated communal blackjack game), such as a secondary poker game driven by outcomes of the primary game (e.g., defined by the seven (7) cards initially dealt in the underlying blackjack game), in accordance with embodiments described herein.

Any or all of the exemplary instructions and data types described herein and other practicable types of data may be stored in any number, type, and/or configuration of memory devices that is or becomes known. The memory device 940 may, for example, comprise one or more data tables or files, databases, table spaces, registers, and/or other storage structures. In some embodiments, multiple databases and/or storage structures (and/or multiple memory devices 940) may be utilized to store information associated with the apparatus 910. According to some embodiments, the memory device 940 may be incorporated into and/or otherwise coupled to the apparatus 910 (e.g., as shown) or may simply be accessible to the apparatus 910 (e.g., externally located and/or situated).

In some embodiments, the apparatus 910 may comprise the cooling device 950. According to some embodiments, the cooling device 950 may be coupled (physically, thermally, and/or electrically) to the processing device 912 and/or to the memory device 940. The cooling device 950 may, for example, comprise a fan, heat sink, heat pipe, radiator, cold plate, and/or other cooling component or device or combinations thereof, configured to remove heat from portions or components of the apparatus 910.

According to some embodiments, the apparatus 910 may comprise the RNG 960. The RNG 960 may comprise, for example, a specially-configured device and/or module for generating random (or pseudo random) numbers, e.g., in accordance with applicable regulations pertaining to gambling or wagering activities. The RNG 960 may comprise, for example, a secure and/or tamper resistant (or tamper evident) module that is inspected and/or approved by a regulatory entity for generating random outcomes for online wagering games.

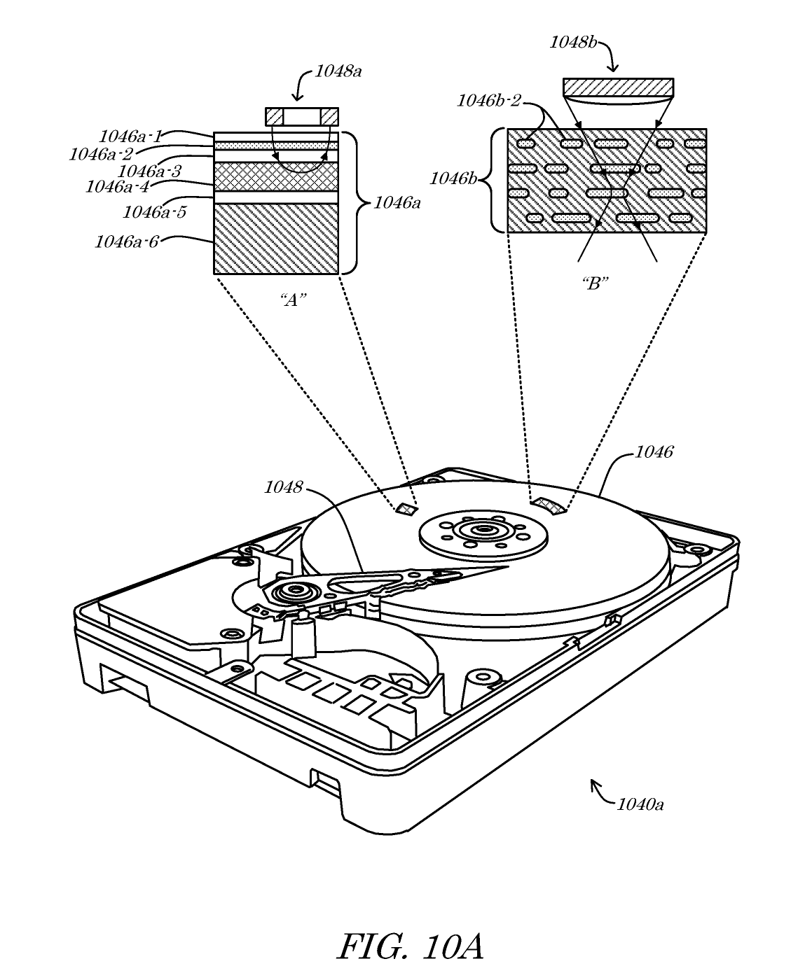

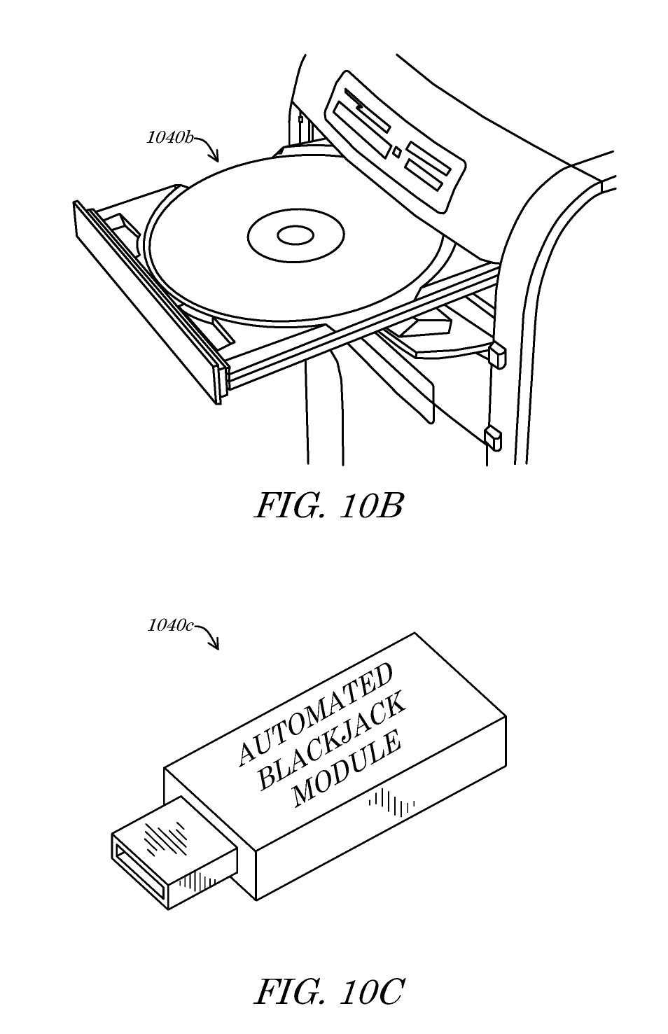

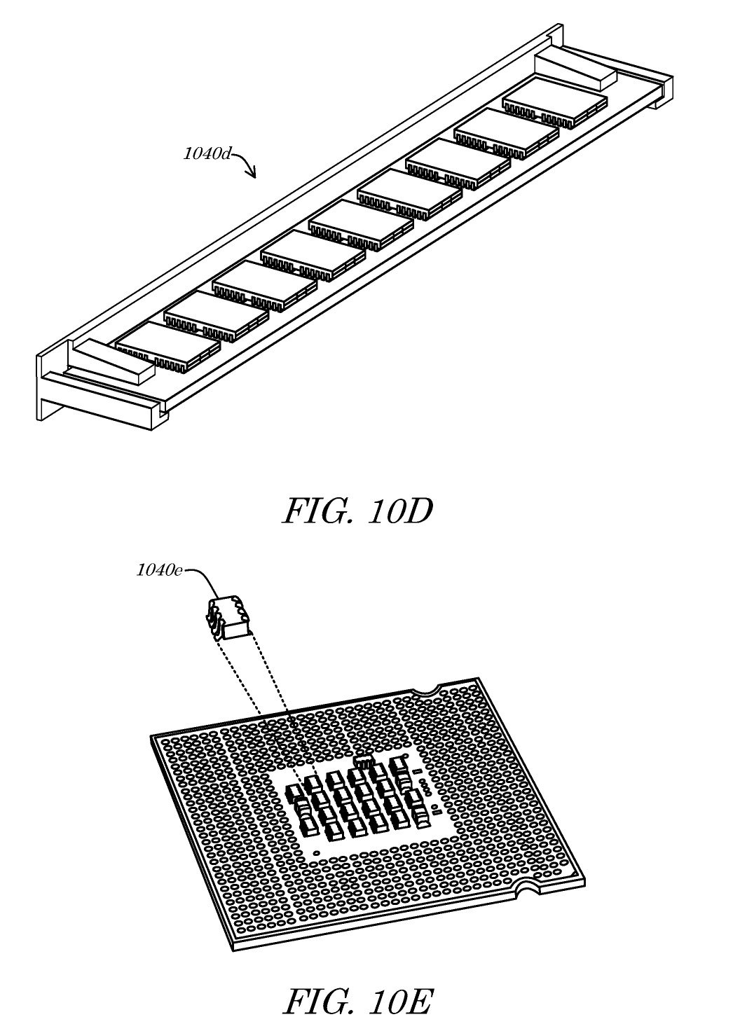

Referring now to FIG. 10A, FIG. 10B, FIG. 10C, FIG. 10D, and FIG. 10E, perspective diagrams of exemplary data storage devices 1040a-e according to some embodiments are shown. The data storage devices 1040a-e may, for example, be utilized to store instructions and/or data such as the primary game instructions 942-1, secondary game instructions 942-2, player data 944-1, wager data 944-2, automated game play data 944-3, and/or results data 944-4, each of which is described in reference to FIG. 9 herein. In some embodiments, instructions stored on the data storage devices 1040a-e may, when executed by a processor, cause the implementation of and/or facilitate the methods 600, 800 of FIG. 6 and/or FIG. 8 herein, and/or portions and/or combinations thereof.

According to some embodiments, the first data storage device 1040a may comprise one or more various types of internal and/or external hard drives. The first data storage device 1040a may, for example, comprise a data storage medium 1046 that is read, interrogated, and/or otherwise communicatively coupled to and/or via a disk reading device 1048. In some embodiments, the first data storage device 1040a and/or the data storage medium 1046 may be configured to store information utilizing one or more magnetic, inductive, and/or optical means (e.g., magnetic, inductive, and/or optical-encoding). The data storage medium 1046, depicted as a first data storage medium 1046a for example (e.g., breakout cross-section “A”), may comprise one or more of a polymer layer 1046a-1, a magnetic data storage layer 1046a-2, a non-magnetic layer 1046a-3, a magnetic base layer 1046a-4, a contact layer 1046a-5, and/or a substrate layer 1046a-6. According to some embodiments, a magnetic read head 1046a may be coupled and/or disposed to read data from the magnetic data storage layer 1046a-2.

In some embodiments, the data storage medium 1046, depicted as a second data storage medium 1046b for example (e.g., breakout cross-section “B”), may comprise a plurality of data points 1046b-2 disposed with the second data storage medium 1046b. The data points 1046b-2 may, in some embodiments, be read and/or otherwise interfaced with via a laser-enabled read head 1048b disposed and/or coupled to direct a laser beam through the second data storage medium 1046b.

In some embodiments, the second data storage device 1040b may comprise a CD, CD-ROM, DVD, Blu-Ray™ Disc, and/or other type of optically-encoded disk and/or other storage medium that is or becomes known or practicable. In some embodiments, the third data storage device 1040c may comprise a USB keyfob, dongle, and/or other type of flash memory data storage device that is or becomes know or practicable. In some embodiments, the fourth data storage device 1040d may comprise RAM of any type, quantity, and/or configuration that is or becomes practicable and/or desirable. In some embodiments, the fourth data storage device 1040d may comprise an off-chip cache such as a Level 2 (L2) cache memory device. According to some embodiments, the fifth data storage device 1040e may comprise an on-chip memory device such as a Level 1 (L1) cache memory device.

The data storage devices 1040a-e may generally store program instructions, code, and/or modules (e.g., a combination of native instructions and downloaded and/or non-authorized software instructions) that, when executed by a processing device cause a particular machine to function in accordance with one or more embodiments described herein. The data storage devices 1040a-e depicted in FIG. 10A, FIG. 10B, FIG. 10C, FIG. 10D, and FIG. 10E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an game provider may, for example, comprise various specialized computers that interact to provide for automated communal blackjack games as described herein.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed herein, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

### V. Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

### VI. Computerized Processing

Various embodiments described herein provide advantages in computer processing. The number of online gaming transactions that can effectively be input, processed, and output in accordance with embodiments herein, for example, would not be possible without implementation of such embodiments in a specialized computer processing system. Such a system as described herein may, for example, enable processing of tens, hundreds, and/or thousands of gaming transactions in minutes, hours, or within a day, while such processing would not be possible in the absence of such a system. For convenience, such a specially-programmed system may be referred to herein as a “specialized computer processing system”. In other words, embodiments conducted by a specialized computer processing system may not be possible to achieve in the absence of such a system and/or the speed at which such a system operates would simply not be reproducible by other available means. As a non-limiting example, a specialized computer processing system herein may be capable of receiving input descriptive of, processing, and outputting sorted bingo card win conditions to one thousand (1000) players in less than one (1) hour.

What is claimed is:

1. An automated play communal blackjack system, comprising:
a processing device;
an RNG device in communication with the processing device;
a network communication device in communication with the processing device; and
a memory device in communication with the processing device, the memory device storing automated game play instructions, that when executed by the processing device result in:
initiating, by the processing device, an electronic session of the automated play communal blackjack game, the initiating comprising providing a game interface to a plurality of remote network devices, and the session comprising a definition of a dealer hand position and a plurality of player hand positions;
receiving, by the network communication device and from the plurality of remote network devices, indications of a plurality of wagers from a plurality of remote players associated with the plurality of remote network devices;
transmitting, by the processing device and to the RNG device, a first call for a first plurality of randomly generated playing cards;
defining, by the processing device and based on the first plurality of randomly generated playing cards, an initial dealer hand for the dealer hand position and an initial player hand for each of the plurality of player hand positions;
computing, by the processing device and via an execution of the automated game play instructions, and utilizing the initial hands as input, at least one automated game play decision;
transmitting, by the processing device and to the RNG device, a second call for a second at least one randomly generated playing card;
defining, by the processing device and based on the second at least one randomly generated playing card and the initial hands, a final dealer hand for the dealer hand position and a final player hand for each of the plurality of player hand positions;
computing, by the processing device and based on the final hands, at least one outcome of the automated play communal blackjack game; and
outputting, by the network communication device and to at least one of the remote network devices, an indication of the at least one outcome of the automated play communal blackjack game.

2. The system of claim 1, wherein the execution of the automated game play instructions by the processing device further results in:
outputting, by the network communication device and to at least one of the remote network devices, an indication of the initial hands.

3. The system of claim 1, wherein the execution of the automated game play instructions by the processing device further results in:
outputting, by the network communication device and to at least one of the remote network devices, an indication of the final hands.

4. The system of claim 1, wherein the execution of the automated game play instructions by the processing device further results in:
outputting, by the network communication device and to at least one of the remote network devices, an indication of the at least one automated game play decision.

5. The system of claim 1, wherein the automated play communal blackjack game comprises a primary game and wherein execution of the automated game play instructions by the processing device further results in:
defining, by the processing device and as part of a secondary game, a poker hand formed from the first plurality of randomly generated playing cards;
computing, by the processing device and based on at least one secondary game rule for the secondary game, a result of the secondary game; and
outputting, by the network communication device and to at least one of the remote network devices, an indication of the result of the secondary game.

6. The system of claim 1, wherein each wager of the plurality of wagers is placed on all of the player positions from the plurality of player hand positions.

7. The system of claim 1, wherein each wager of the plurality of wagers is placed on a different one of the player positions from the plurality of player hand positions.

8. The system of claim 1, wherein the receiving of the plurality of wagers is conducted via a plurality of respective interface elements output by the remote network devices.

9. The system of claim 8, wherein the plurality of respective interface elements are output for a predetermined limited period.

10. An automated play communal blackjack system for playing an online automated play communal blackjack game that accepts wagers from a plurality of players for at least one communal blackjack hand, automatically processes game play of a single game session without acceptance of game play input from any of the plurality of players, resolves at least one result of the automated play communal blackjack game, and outputs the at least one result to at least one of the plurality of players, the system comprising a plurality of processing devices for automatically computing game play decisions for the plurality of players simultaneously.
